(19) United States
(12) Patent Application Publication
(10) Pub. No.: US 2021/0253452 A1
(43) Pub. Date: Aug. 19, 2021

(54) ELECTROCHEMICAL FLOW REACTOR

(71) Applicant: COMMONWEALTH SCIENTIFIC AND INDUSTRIAL RESEARCH ORGANISATION, Acton (AU)

(72) Inventors: Michael David HORNE, Acton (AU); Bita BAYATSARMADI, Acton (AU); Theo RODOPOULOS, Acton (AU); John TSANAKTSIDIS, Acton (AU); Dayalan Romesh GUNASEGARAM, Acton (AU); Christian HORNUNG, Acton (UA); Darren FRASER, Acton (AU); Dylan MARLEY, Acton (AU); Andrew Joseph URBAN, Acton (AU)

(21) Appl. No.: 17/266,192

(22) PCT Filed: Aug. 7, 2019
(86) PCT No.: PCT/AU2019/050827

§ 371 Date: Feb. 5, 2021

(30) Foreign Application Priority Data
Aug. 8, 2018 (AU) 2018902887

(51) Int. Cl. C02F 1/461; C25C 7/02; C25B 9/19; C25B 11/02; C02F 1/467; B01F 5/06

(52) U.S. Cl. CPC C02F 1/46109; B01F 2215/0445; C25B 9/19; C25B 11/02; C02F 1/4678; B01F 5/0619; C02F 2001/46171; C02F 2201/46115; C02F 2201/4611; C02F 2201/4614; C02F 2301/02; B01F 2005/0626; B01F 2215/0052; B01F 2215/0036; B01F 2215/0459; B01F 2215/045; C25C 7/02

(57) ABSTRACT

The present disclosure relates to an electrochemical flow reactor, such as a continuous flow electrochemical tubular reactor. This disclosure also relates to processes, systems, and methods comprising an electrochemical flow reactor. An electrochemical flow cell can comprise a reaction chamber, a first static mixer electrode, a second counter electrode, and a separator disposed between the first and second electrodes.

### FIELD

The present disclosure relates to an electrochemical flow reactor, such as a continuous flow electrochemical tubular reactor. This disclosure also relates to processes, systems, and methods comprising an electrochemical flow reactor.

### BACKGROUND

Continuous flow reactors generally comprise a reaction chamber where reactant fluids are continuously fed to undergo a chemical reaction to form products that are provided in a continuous output stream from the reaction chamber. The reaction chambers are typically submerged in a heating/coolant fluid, for example in a shell-and-tube heat exchanger configuration, to facilitate the transfer of heat to/away from the reaction.

Continuous flow reactors can employ packed bed reaction chambers in which the reaction chamber is packed with solid catalyst particles that provide catalytic surfaces on which the chemical reaction can occur. Static mixers can be used for pre-mixing of fluid streams prior to contact with the packed bed reaction chambers and downstream of these chambers to transfer heat between the central and the outer regions of the reactor tubes. The static mixers comprise solid structures that interrupt the fluid flow to promote mixing of the reactants prior to reaction in the packed bed reaction chambers and for promoting desirable patterns of heat and mass transfer downstream of these chambers.

Electrochemical flow reactors have been used in treatment of fluid streams to remove dissolved metals by electrodeposition of dissolved metal ions to form solid metal products on the surface of electrodes housed in the electrochemcial flow reactors. Electrochemical flow reactors for water treatment have been directed to low flow systems with high surface area electrodes for high efficiency and control in removing dissolved metals from aqueous fluid streams having dilute/low concentrations of dissolved metal ions. Electrochemical flow reactors are also used in electrosynthesis of various products, and in particular for forming reactants or intermediate products.

There is a need for alternative or improved electrochemical flow reactors for providing efficient mixing, high mass transfer, and/or versatile operation for industrial applications.

It will be understood that any prior art publications referred to herein do not constitute an admission that any of these documents form part of the common general knowledge in the art, in Australia or in any other country.

### SUMMARY

The present inventors have undertaken research and development into alternative electrochemical flow reactors and have identified that static mixers can be configured to operate as an electrode within an electrochemical flow reactor to achieve efficient mixing, high mass transfer, and/or versatile operation for use in industrial applications. The electrochemical flow reactors can comprise a static mixer electrode separated from a counter electrode by a permeable membrane. The static mixer electrode can be configured for enhancing mass transfer and chaotic advection while providing effective performance. The static mixer electrode can be an electrode comprising a static mixer portion.

In one aspect, there is provided an electrochemical flow cell comprising:

a reaction chamber;

a first electrode;

a second electrode; and

a separator disposed between the first and second electrodes, the separator at least partially defining a first channel within the reaction chamber configured to accommodate a first fluid stream in contact with the first electrode and a second channel within the reaction chamber configured to accommodate a second fluid stream in contact with the second electrode,

wherein the separator comprises a permeable membrane that allows ionic communication between the first and second electrodes via the fluid streams while restricting fluid exchange between the fluid streams, and

wherein the first electrode comprises a static mixer portion defining a plurality of splitting structures that split the first fluid stream into a plurality of sub-streams at a plurality of locations along a length of the first electrode.

In an embodiment, the electrochemical flow cell is a continuous flow tubular reactor.

In an embodiment, the diameter of the static mixer portion of the first electrode may be approximately equal to a diameter of the first channel. The first electrode may be arranged for contact with the separator. The separator and second electrode may be arranged concentrically and coaxial with a central longitudinal axis of the first electrode. The separator and second electrode may be substantially cylindrical. The second electrode may form at least part of a wall of the reaction chamber.

In an embodiment, the first electrode comprising a static mixer portion may be configured for enhancing mass transfer and chaotic advection by defining a plurality of splitting structures that split a fluid stream into a plurality of sub-streams at a plurality of locations along a length of the first electrode.

In an embodiment, adjacent splitting structures of the static mixer portion may be arranged at different angles of rotation about a central longitudinal axis of the static mixer portion. The static mixer portion may comprise a plurality of substantially similar structural modules arranged consecutively along a length of the static mixer portion. The first electrode comprising the static mixer portion may be configured to enhance chaotic advection by splitting the first fluid stream by more than 200 m⁻¹, corresponding to a number of times the first fluid stream is split within a given length along the static mixer portion of the first electrode.

In another embodiment, the first electrode comprising the static mixer portion is configured for operating at a Peclet (Pe) number of at least about 10,000. The first electrode comprising the static mixer portion may be configured for operating at a pressure drop across the first electrode (in Pa/m) of between about 100 to 100,000. The first electrode comprising the static mixer portion may be configured for operating within the first channel to provide a volumetric flow rate for the first fluid stream of at least about 0.1 ml/min.

In another aspect, there is provided an electrochemical flow system comprising at least a first electrochemical flow cell according to any aspect, embodiment or example of the electrochemical flow cell as described herein.

In an embodiment, the electrochemical flow system comprises a first and second electrochemical flow cell according to any aspect, embodiment or example of the electrochemical flow cell as described herein. A plurality of flow lines may be provided to connect the first electrochemical flow cell to the second electrochemical flow cell such that the first channel of the first electrochemical flow cell is in fluid communication with the second channel of the second electrochemical flow cell, and the second channel of the first electrochemical flow cell is in fluid communication with the first channel of the second electrochemical flow cell.

In an embodiment, the electrochemical flow system further comprises:

a pump for providing fluidic flow of the fluid streams;

a power supply for controlling current through, or voltage applied to, the electrodes;

a controller for controlling one or more parameters of the system comprising concentration, flow rate, temperature, pressure, and residence time.

In another aspect, there is provided a method for electrochemical treatment of a fluid stream comprising an electrochemical flow cell according to any aspect, embodiment or example of the electrochemical flow cell, reactor or system thereof as described herein. The method may be for treating waste-water, removal of dissolved metal ions from a fluid stream, or recovery of metal from a fluid stream.

In an embodiment of the method, the electrochemical flow cell comprising the first electrode comprising the static mixer portion may be operated to provide at least one of:

a chaotic advection by splitting the first fluid stream by more than 200 m⁻¹, corresponding to a number of times the first fluid stream is split within a given length along the static mixer portion of the first electrode;

a Peclet (Pe) number of at least about 10,000;

a pressure drop across the first electrode (in Pa/m) of between about 100 to 100,000;

a volumetric flow rate for the first fluid stream of at least about 0.1 ml/min;

a current density on the first and second electrode of between about 1 μA m⁻² to about 1000 A m⁻².

The method may comprise operation of a first and second electrochemical flow cell according to any aspect, embodiment or example of the electrochemical flow cell as described herein, wherein a plurality of flow lines connects the first electrochemical flow cell to the second electrochemical flow cell such that the first channel of the first electrochemical flow cell is in fluid communication with the second channel of the second electrochemical flow cell, and the second channel of the first electrochemical flow cell is in fluid communication with the first channel of the second electrochemical flow cell.

In another aspect, there is provided a method for electrochemical synthesis of a product comprising an electrochemical flow cell according to any aspect, embodiment or example of the electrochemical flow cell, reactor or system thereof as described herein.

In another aspect, there is provided a method for removal of a species from a fluid stream comprising an electrochemical flow cell, reactor or system thereof according to any aspects, embodiments or examples thereof as described herein. The species may be a metal species dissolved in the fluid stream.

It will be appreciated that other aspects, embodiments and examples of the electrochemical flow cell, reactor or system are described herein.

### BRIEF DESCRIPTION OF THE DRAWINGS

Preferred embodiments of the present disclosure are further described and illustrated as follows, by way of example only, with reference to the accompanying drawings in which:

FIG. 1 shows a schematic diagram of an electrochemical flow cell according to some embodiments;

FIG. 2 shows a schematic diagram of an electrochemical flow cell with a separator according to some embodiments;

FIG. 3A shows a perspective view of a static mixer electrode according to some embodiments;

FIG. 3B shows (in isolation) a perspective view of a static mixer portion of the static mixer electrode of FIG. 3A;

FIG. 3C shows (in isolation) a cross-sectional view of a static mixer portion of the static mixer electrode of FIG. 3A;

FIG. 3D shows (in isolation) a side view of a static mixer portion of the static mixer electrode of FIG. 3A;

FIG. 4A shows a perspective view of an electrochemical flow cell according to some embodiments;

FIG. 4B shows a perspective view of the flow cell of FIG. 4A in a disassembled configuration;

FIG. 4C shows a cross-sectional view of the flow cell of FIG. 4A;

FIG. 5 shows a perspective view of an end cap of the flow cell of FIG. 4A;

FIG. 6 shows a schematic diagram of an electrochemical flow system comprising two electrochemical flow cells, according to some embodiments;

FIG. 7 shows chronoamperometric responses in 100 seconds with intervals of 50 seconds in stationary mode and 50 seconds in constant flow rate of 10 to 400 mL min−1 at constant potentials of (a) −1.4 V, (b) −1.6 V, (c) −1.8 V and (d) −2 V (0.001 M K₃[Fe(CN)₆]);

FIG. 8 shows chronoamperometric responses in 100 seconds with intervals of 50 seconds in stationary mode and 50 seconds in constant flow rate of 10 to 400 mL min−1 at constant potentials of (a) −1.4 V, (b) −1.6 V, (c) −1.8 V and (d) −2 V (0.01 M K₃[Fe(CN)₆]);

FIG. 9 shows chronoamperometric responses in 100 seconds with intervals of 50 seconds in stationary mode and 50 seconds in constant flow rate of 10 to 400 mL min−1 at constant potentials of (a) −1.4 V, (b) −1.6 V, (c) −1.8 V and (d) −2 V (0.1 M K₃[Fe(CN)₆]);

FIG. 10 shows an electrochemical flow cell efficiency in removal of copper ion from 0.01M sulphuric acid solution at three different concentration of Cu2+;

FIG. 11 shows (a) Optical image of static mixer working electrode pre and post processes, (b) EDS analysis and (c-e) SEM images of static mixer electrode after 5 hours electrolysis; and

FIG. 12 shows copper concentration vs time over 24 hours operation according to a separated configuration embodiment of the electrochemical flow cell.

### DETAILED DESCRIPTION

The present disclosure describes the following various non-limiting embodiments, which relate to investigations undertaken to identify electrochemical flow reactors capable of providing efficient mixing, high mass transfer, and/or versatile operation for industrial applications. It was surprisingly found that an electrode comprising a static mixer portion could be configured within an electrochemical flow cell to achieve efficient mixing, high mass transfer, and/or versatile operation for use in industrial applications. It was also found that an efficient electrochemical reactor could be provided where the electrode comprising the static mixer portion was configured for enhancing mass transfer and chaotic advection. Further surprising advantages around system operation and performance were identified by configuring a separator between the electrode comprising the static mixer portion and the counter electrode to provide each of the electrodes in ionic communication and in separate fluid channels.

### Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

The term “and/or”, e.g., “X and/or Y” means either “X and Y” or “X or Y” and is taken to provide explicit support for both meanings or for either meaning.

As used herein, the term “about”, unless stated to the contrary, typically refers to +/−10%, for example +/−5%, of the designated value.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Those skilled in the art will appreciate that the disclosure herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations or any two or more of said steps or features.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### Electrochemical Flow Reactor

An electrochemical flow cell may be provided comprising: a reaction chamber; a first electrode comprising a static mixer portion; a second electrode; and a separator disposed between the first and second electrodes.

The separator may at least partially define a first channel within the reaction chamber to accommodate a first fluid stream in contact with the first electrode and a second channel within the reaction chamber to accommodate a second fluid stream in contact with the second electrode. It will be appreciated that the separator allows ionic communication between the first and second electrodes via the fluid streams. The separator may be a permeable membrane that restricts fluid exchange between the fluid streams. The static mixer portion may define a plurality of splitting structures that split a fluid stream into a plurality of sub-streams at a plurality of locations along a length of the first electrode. It will be appreciated that the static mixer portion as part of the electrode is electrically conductive. Further embodiments and details of the electrochemical flow cell are described as follows.

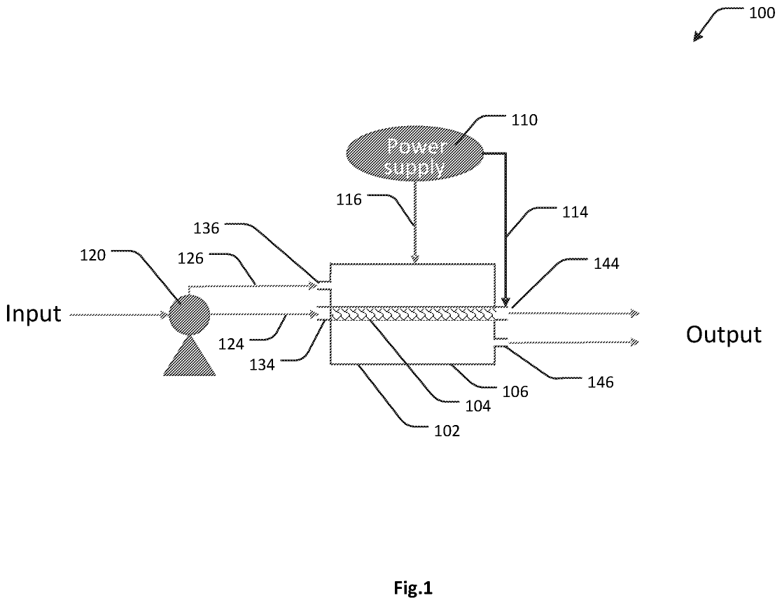

Referring to FIG. 1, an electrochemical flow cell 100 (without separator shown) comprises a reaction chamber 102 containing a first electrode 104 and a second electrode 106. The second electrode 106 may form at least part of a wall of the reaction chamber 102 as shown in FIG. 1. The first electrode 104 may comprise a static mixer. The second electrode 106 may comprise a static mixer. The first and second electrodes 104, 106 may be arranged concentrically, with one surrounding the other, or in a side-by-side configuration.

An electrical power supply 110 may be connected to the first and second electrodes 104, 106 via respective first and second electrical conductors or cables 114, 116 to apply a potential difference or voltage across the electrodes 104, 106. In some embodiments, the first electrode 104 may act as an anode, and the second electrode 106 may act as a cathode. In some embodiments, the first electrode 104 may act as a cathode, and the second electrode 106 may act as an anode. In some embodiments, a negative potential may be applied to the first electrode 104, and a positive potential may be applied to the second electrode 106. In some embodiments, a positive potential may be applied to the first electrode 104, and a negative potential may be applied to the second electrode 106.

The first and second electrodes 104, 106 may be formed of an electrically conductive material, or may comprise an electrically conductive surface coating. Further characteristics of the electrodes 104, 106 are described below according to various embodiments and examples.

A pump 120 may be arranged to flow fluid into the reaction chamber 102 via a first fluid flow line 124 through a first inlet 134 in the reaction chamber 102 to flow fluid through or around the first electrode 104. The pump 120 may also be arranged to flow fluid into the reaction chamber 102 via a second fluid flow line 126 through a second inlet 136 in the reaction chamber 102 to flow fluid between the first electrode 104 and the second electrode 106. The fluid may then flow out of the reaction chamber 102 via a first outlet 144 adjacent the first electrode 104 and a second outlet 146 nearer the second electrode 106.

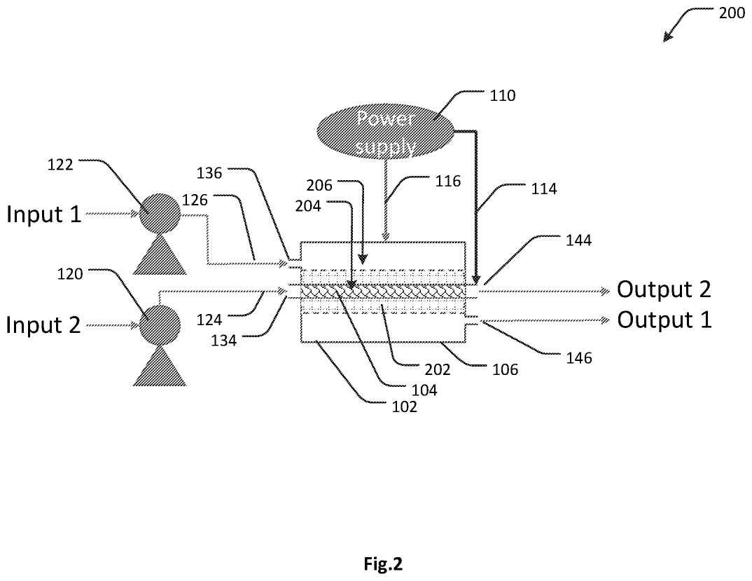

In some embodiments, the first and second flow lines 124, 126 may be supplied with fluid independently from a first pump 120 and a second pump 122, as shown in FIG. 2. In some embodiments, the first and second flow lines 124, 126 may provide different fluids to the reaction chamber 102. The flow lines 124, 126 may comprise pipes or tubes, for example.

Referring to FIG. 2, an electrochemical flow cell 200 is provided according to some embodiments (with separator shown). The flow cell 200 is similar to the flow cell 100 described in relation to FIG. 1, and like reference numerals are used for like components. In addition to the components shown in flow cell 100 and recited above, flow cell 200 comprises a separator 202. The separator in the embodiment as shown in FIG. 2 at least partially separates a first fluid in, around or adjacent the first electrode 104 from a second fluid adjacent the second electrode 106 between the first and second electrodes 104, 106. The separator 202 may cooperate with walls of the reaction chamber 102 to define a first channel 204 and a second channel 206. The first electrode 104 may be disposed in the first channel 204 and the second electrode 106 may be disposed in or form a wall of the second channel 206. The inlets 134, 136 and outlets 144, 146 may be configured such that the first fluid flows through the first channel 204 and the second fluid flows through the second channel 206. In some embodiments, a ratio between lateral cross-sectional areas of the first channel 204 and the second channel 206 may be in the range of 0.01 to 100, 0.1 to 10, 0.5 to 5, 0.3 to 1, 0.5 to 0.9, 0.5 to 1.5 or 0.8 to 1.2, for example.

The separator 202 may allow the flow of electrical charge between the electrodes 104, 106, but restrict the bulk of the fluid from passing through the separator 202. In some embodiments, the separator 202 may allow ionic communication between the first and second electrodes 104, 106. For example, ions may be allowed to pass from the first channel 204 to the channel fluid 206, or from the second channel 206 to the first channel 204, while other components of the fluids may be prevented or substantially restricted from passing through the separator 202. In some embodiments, a small amount of fluid may pass through the separator 202, although the separator 202 may be configured to substantially impede fluid flow through the separator 202. In some embodiments, the separator 202 may comprise a permeable membrane, a semipermeable membrane or a selectively permeable membrane. The characteristics of the separator 202 are described in further detail below according to various embodiments.

In some embodiments, the separator 202 and walls of the reaction chamber 102 may be arranged to define the channels 204, 206 in a side-by-side relationship. The separator 202 may be substantially planar extending between the channels 204, 206. In some embodiments, the channels 204, 206 may extend substantially in parallel. In some embodiments, the second channel 206 may partially surround the first channel 204. In some embodiments, the first and second channels 204, 206 may be arranged concentrically. In some embodiments, the first channel 204 may be defined entirely by an internal surface of the separator 202. In some embodiments, the separator 202 and chamber 102 may be substantially cylindrical. In some embodiments, the chamber 102 may be substantially coaxial with the separator 202. In some embodiments, the second electrode 106 may be substantially coaxial with the first electrode 104. In some embodiments, the walls of the chamber 102 and the separator 202 may all be substantially cylindrical and coaxial with a central longitudinal axis of the first electrode 104.

In some embodiments, the separator 202 may define surface variations or undulations to increase the surface area of the separator 202. In some embodiments, the separator 202 may be corrugated. In some embodiments, the separator 202 may be substantially cylindrical with longitudinal corrugations. In some embodiments, the separator 202 may be substantially cylindrical with circumferential corrugations.

The first electrode 104 (and/or second electrode 106) may comprise a static mixer portion (e.g. static mixer element or SME) which defines a structure having a geometry configured to promote mixing of fluid flowing through the static mixer between the bulk of the fluid and the electrode surface as well as within the fluid itself. The first electrode may be a static mixer electrode. The static mixer electrode 104 may be configured to split the flow at multiple different splitting locations along a length of the electrode 104 to promote thorough mixing via chaotic advection.

The static mixer may define a plurality of splitting structures arranged at the splitting locations to split the flow. The splitting structures may be arranged at different azimuthal angles at the different locations to split the flow at different angles. In some embodiments, the splitting structures may be configured to split the flow into two sub-streams at each splitting location. In some embodiments, the splitting structures may be configured to split the flow into at least three, sub-streams at each splitting location, such as three, four, five, six, seven or eight sub-streams, for example.

The geometry of the static mixer may be configured for enhanced chaotic advection based on properties of a particular fluid. The structure of the static mixer may comprise networks of elements including one or more of: intersecting blades or vanes, struts, asperities, undulations and protrusions, helices, corrugated-plates, open configurations, closed configurations, pores, channels, holes, tubes, and multilayer designs.

The geometry may be regularly repeated along the length of the mixer or it may vary in size, type and/or shape. The geometry may also vary in its characteristic length from the scale of the mixer to nanometers, and features may be provided at all length scales in between.

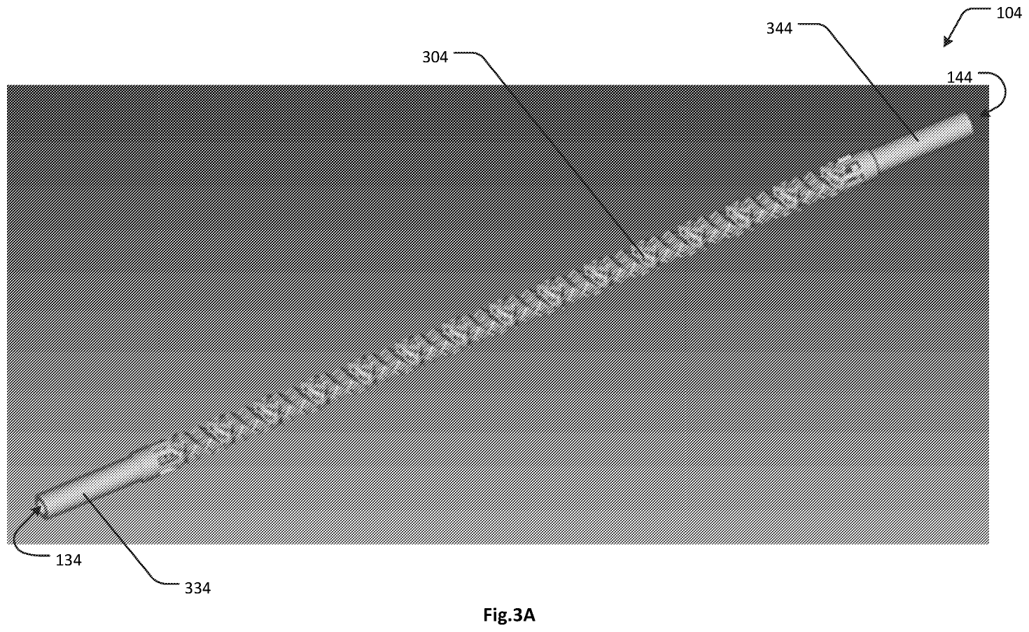

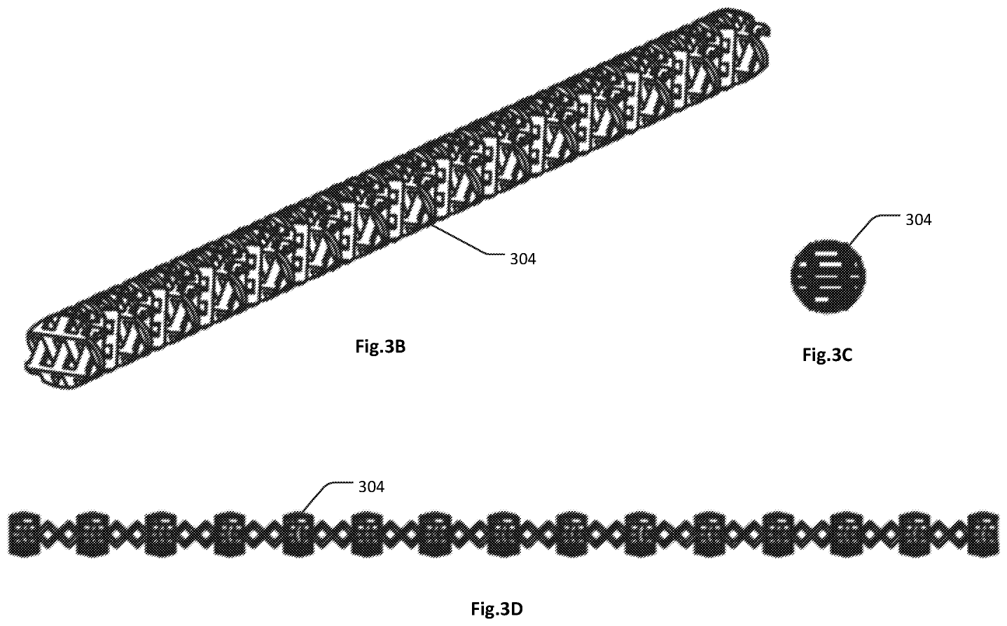

Referring to FIGS. 3A to 3D, a static mixer electrode 104 is shown according to some embodiments. The electrode 104 comprises a static mixer portion 304 extending between a first end portion 334 and a second end portion 344. The end portions 334, 344 may define tubes or pipes to direct fluid through the static mixer.

The first end portion 334 may define the first inlet 134 of a flow cell and the second end portion 344 may define the first outlet 144 of the flow cell, such as the flow cells 100, 200 described above in relation to FIGS. 1 and 2. The end portions 334, 344 may also provide an electrical contact area to connect the electrode 104 to the power source 110.

The static mixer portion 304 is shown in FIGS. 3B to 3D without the end portions 334, 344 to show the geometry more clearly, according to some embodiments. The static mixer portion 304 comprises a plurality of rectilinear splitting structures arranged in repeated modules with each subsequent module rotated by 90°, relative to the previous module, around a central longitudinal axis of the static mixer portion extending from one end to the other. The static mixer portion 334 promotes chaotic advection of fluid flowing through the static mixer portion 334, in a general direction along the central longitudinal axis, by splitting and recombining the flow at a plurality of splitting locations along the length of the static mixer portion 334. The splitting structures split the flow into a plurality of sub-streams at each splitting location, and the sub-streams are subsequently recombined before being split by the next splitting structure at the next splitting location.

Each time the flow is split and recombined, it brings different parcels of fluid from the bulk of the flow into contact with the surface of the electrode 104, and splitting the flow multiple times along the length of the static mixer increases the amount of fluid which comes into contact with the electrode 104.

In some embodiments, the diameter of the static mixer electrode 104 may be close to an internal diameter of the separator 202. That is, the first electrode 104 may fit closely within the separator 202. An outer envelope of the static mixer geometry of the first electrode 104 may substantially entirely take up an internal volume defined by the separator 202. In some embodiments, the volume of the first electrode 104 may be in the range of 1% to 99% of the internal volume of the channel 204, optionally 10% to 90%, 20% to 80%, 30% to 70% or 40% to 60%. In some embodiments, the volume of the first electrode 104 may be at least about 10%, 20%, 30%, 40%, 50%, 60%, 70%, 80%, 90%, 95%, 98%, or 99%, of the internal volume of the channel 204. Further characteristics of the static mixer are described below according to various embodiments.

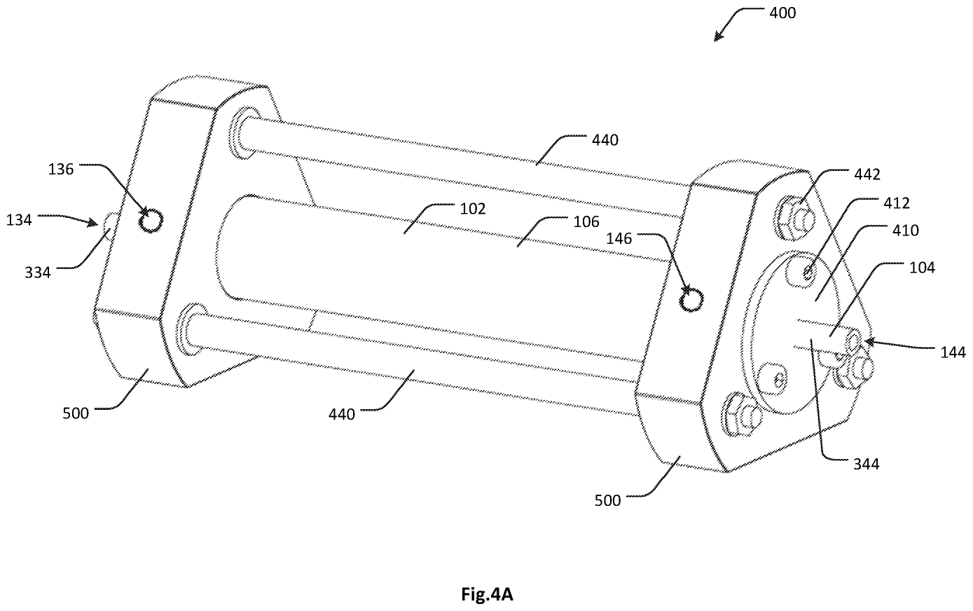

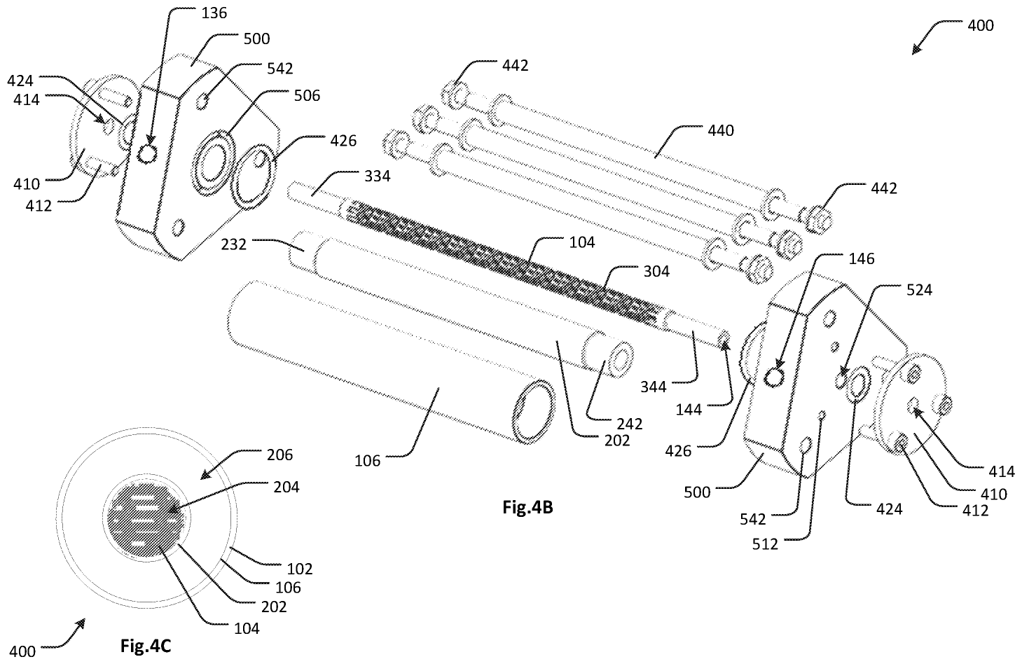

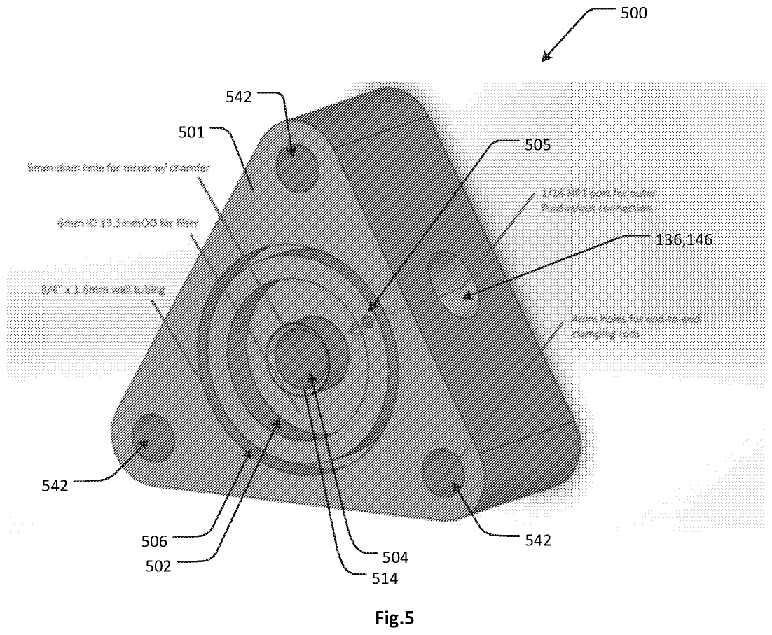

Referring to FIGS. 4A to 4C, an electrochemical flow cell 400 is shown, according to some embodiments, in an assembled configuration (FIG. 4A), in a disassembled configuration (FIG. 4B), and in cross-section (FIG. 4C). Like components are indicated with like reference numerals and may include any of the features of the flow cells 100, 200 and components described in relation to FIGS. 1 and 2 or the static mixer electrode 104 described in relation to FIGS. 3A to 3D.

The flow cell may comprise a first electrode 104, a second electrode 106, and a separator 202 arranged between the first electrode 104 and the second electrode 106. The first electrode 104 may comprise a static mixer electrode 104 as described in relation to FIGS. 3A to 3D, for example.

The separator 202 may comprise a permeable, semipermeable or selectively permeable membrane, which is substantially cylindrical and closely surrounds the static mixer portion 304 of the first electrode 104. The separator 202 and first electrode 104 may cooperate to define a first channel 204 along which fluid can flow, contact the first electrode 104 and be mixed by the static mixer portion 304 (see FIG. 4C).

The second electrode 106 may also be substantially cylindrical and define an outer wall of the reaction chamber 102 surrounding the separator 202 and first electrode 104. The separator 202 and second electrode 106 may cooperate to define a second channel 206 along which fluid can flow and contact the second electrode 106 (see FIG. 4C).

The separator 202 and second electrode 104 may be arranged substantially concentric and/or coaxial with a central longitudinal axis of the first electrode 104.

The separator 202 and electrodes 104, 106 are held in place by two opposing end caps 500, shown in further detail in FIG. 5, according to some embodiments. Each end cap 500 comprises a body 501 defining a separator seat 502, a first electrode seat 504 and a second electrode seat 506.

The second electrode seat 506 is defined by an annular recess in the body 501 configured to receive at least part of an end of the second electrode 106. The flow cell 400 may comprise a second electrode gasket 426 disposed between the second electrode 106 and each end cap 500 to form a seal between the second electrode 106 and the second electrode seat 506 (see FIG. 4B).

The separator seat 502 is defined by an annular recess (or in some embodiments, a circular recess) configured to respectively receive a first end portion 232 or second end portion 242 of the separator 202 (see FIG. 4B). The body 501 defines an opening 516 located between the separator seat 502 and the second electrode seat 506 and a passageway from the opening 516 to define the second outlet 136 or second inlet 146 respectively.

The first electrode seat 504 is defined by a cylindrical bore or passageway configured to receive the respective end portions 334, 344 of the first electrode 104. The first electrode seat 504 may be surrounded by a chamfer 514 on one side of the body 501 to assist in locating the first electrode 104 in the first electrode seat 504. The passageway may extend from the chamfer 514 to a first electrode seat opening 524 on the other side of the body 501 (see FIG. 4B). The first and second end portions 334, 344 of the first electrode 104 may extend through the passageway and opening 524 and respectively define the first inlet 134 or first outlet 144.

A seal may be formed between the end portions 334, 344 and end caps 500 with a sealing plate or gland 410 and a first electrode gasket 424 (see FIG. 4B). The gland 410 may define an electrode opening 414 to allow passage of at least part of the end portions 334, 344, and a plurality of fastener apertures (not shown) to receive a plurality of fasteners 412. The body 501 of the end caps 500 may define a corresponding plurality of fastener recesses 512 configured to receive the fasteners 412. The fasteners 412 may engage (e.g. by thread) the fastener recesses 512 to draw the glands 410 against the end caps 500 compressing the first electrode gaskets 424 between the end caps 500 and glands 410 and against the end portions 334, 344, thereby forming a seal between the first electrode 104 and the end caps 500.

The end caps 500 may be held together by a plurality of tie rods 440 extending between the end caps 500 and through a corresponding plurality of tie rod openings 542 defined in the body 501 of each end cap 500. The tie rods 440 may be configured to receive tie rod fasteners 442 at each end of each tie rod 440 to draw the end caps 500 towards each other and hold the separator 202 and first and second electrodes 104, 106 between the end caps to define the reaction chamber 102 and flow cell 400.

Electrochemical flow cells 100, 200 and 400 may allow for improved efficiencies in electrochemical reactions compared to conventional electrochemical flow cells due to the static mixer geometry of the first electrode 104 (and/or second electrode 106) promoting enhanced mixing of the fluid, such as by chaotic advection, for example, to increase the volume of fluid making contact with the first electrode 104 and/or second electrode 106.

Electrochemical flow cells 200 and 400 may provide a further advantage in that to fluid streams may be kept substantially separate in the channels 204, 206 on either side of the separator 202. This allows for independent input fluids to be kept substantially separate, while still allowing electrochemical reactions to occur. For example, in some processes, a particular substance, such as metal ions, for example, may be deposited on a surface of one of the electrodes 104, 106 via electrodeposition.

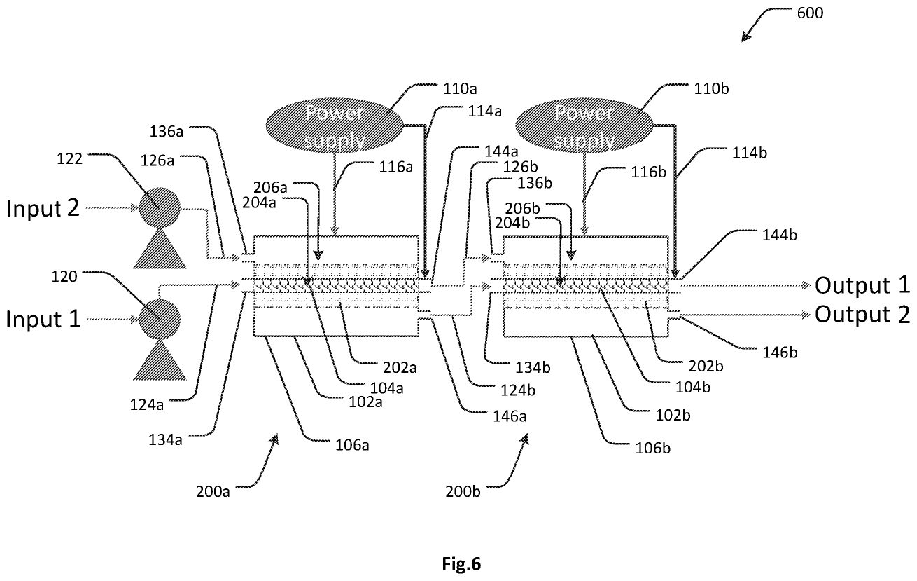

Referring to FIG. 6, an electrochemical flow system 600 is shown according to some embodiments. The system 600 comprises a first flow cell 200a and a second flow cell 200b arranged in series and powered by two power supplied 110a and 110b, respectively. Although, in some embodiments, a single power supply 110 may power both flow cells 200a, 200b. The electrochemical flow cells 200a, 200b may be substantially similar to flow cells 200 or 400 and include any of the features of the components described above in relation to FIGS. 2 to 5.

The system 600 may comprise a first pump 120 supplying a first fluid from a first source (Input 1) into the first inlet 134a of the first flow cell 200a via the first flow line 124a of the first flow cell 200a, and a second pump 122 supplying a second fluid from a second source (Input 2) into the second inlet 136a of the first flow cell 200a via the second flow line 126a of the first flow cell 200a. The first and second electrodes 104b, 106b of the second flow cell 200b may be supplied with an electrical voltage in reverse polarity with respect to a voltage applied to the first and second electrodes 104a, 106a of the first flow cell 200a.

The system 600 may be configured such that the first fluid flowing into the first inlet 134a of the first flow cell 200a flows through the first channel 204a and out through the first outlet 144a of the first flow cell 200a; then into the second inlet 136b of the second flow cell 200b via second flow line 126b; through the second channel 206b of the second flow cell 200b and out through the second outlet 146b into a first reservoir (Output 1). The system 600 may further be configured such that the second fluid flowing into the second inlet 136a of the first flow cell 200a flows through the second channel 206a and out through the second outlet 146a of the first flow cell 200a; then into the first inlet 134b of the second flow cell 200b via first flow line 124b; through the first channel 204b of the second flow cell 200b and out through the first outlet 144b into a second reservoir (Output 2).

For example, the first fluid source may include a contaminant metal, such as copper, and there may be a desire to remove the contaminant from the first fluid source and transfer the contaminant to the second fluid. When flowed through the system 600, the contaminant will be deposited onto the first electrode 104a of the first flow cell 200a from the first fluid, and if there is any contaminant left in the first fluid after passing through the first flow cell 200a, the contaminant will also be deposited on the second electrode 106b of the second flow cell 200b as the first fluid flows through the second channel 206b of the second flow cell 200b. The second fluid will pass through the second channel 206a of the first flow cell 200a and the first channel 204b of the second flow cell 200b to allow electrical contact and complete the galvanic circuit for each flow cell 200a, 200b.

In conventional systems, when the contaminant has built up on an electrode via electrodeposition, the electrode is removed from the system and the deposited contaminant is mechanically removed from the surface of the electrode. However, when the system 600 is employed, it is not necessary to remove the electrodes.

Once the contaminant has been deposited on the first electrode 104a of the first flow cell 200a and the second electrode 106b of the second flow cell 200b, the fluid sources may be switched by swapping the flow lines 124a, 126a or using inline valves or gates (not shown) such that the first fluid flows through the second channel 206a of the first flow cell 20a and the first channel 204b of the second flow cell 200b and the second fluid flows through the first channel 204a of the first flow cell 200a and the second channel 206b of the second flow cell 200b. In this way, the contaminant will be removed from the surfaces of the first electrode 104a of the first flow cell 200a and the second electrode 106b of the second flow cell 200b, and more of the contaminant will be removed from the first fluid and deposited on the second electrode 106a of the first flow cell 200a and the first electrode 104b of the second flow cell 200b.

Electrochemical flow system 600 allows for an electrochemical reaction to proceed indefinitely with relatively short interruptions to switch the fluid paths compared with conventional systems which require physical removal and replacement of the electrodes when the material deposited on the electrodes has reached a certain threshold.

### Electrochemical Tubular Reactor

The electrochemical flow reactor, for example the above described electrochemical flow cell, may be provided in the form of a continuous flow electrochemical tubular reactor. The continuous flow electrochemical tubular reactor may be provided according to any embodiments or examples as described herein for the electrochemical flow cell.

It will be appreciated that a tubular rector can be provided in various shapes, elongations and configurations. For example, a tubular reactor may include a reactor chamber of a circular or non-circular shape, or where the reactor chamber comprises one or more fluid channels that are of a circular or non-circular circumferential shape. Examples of non-circular shapes may include rectangular, isosceles triangular, elliptical, trapezoidal and hexagonal. In one embodiment, the tubular reactor or reactor chamber is of a substantially circular or cylindrical shape.

The continuous flow electrochemical tubular reactor may comprise a reactor housing defining a reactor chamber for accommodating at least one static mixer electrode spaced apart from at least one counter electrode. The static mixer electrode may be provided by an electrode comprising a static mixer portion or static mixer element as described herein. It will be appreciated that the static mixer portion or static mixer element, or at least a portion of any coating thereon, can be electrically conductive. The reactor also comprises a permeable membrane acting as a separator for fluidically separating the static mixer electrode from the counter electrode while providing an electrical connection between the electrodes. The reactor can provide a fluid channel for housing the static mixer electrode that is separate to a fluid channel that houses the counter-electrode. The pair of electrodes can provide a cathode and anode pair for driving an electrochemical reaction in the tubular reactor. The static mixer electrode and counter electrode may be either the cathode or anode depending on current flow in the electrochemical cell. For example, the electrode pair may be reversed by switching current flow. The static mixer electrode can also be configured for enhancing mass transfer and chaotic advection.

It will be appreciated that the tubular reactor is configured to permit at least a first fluid stream to flow across the static mixer electrode to undergo chaotic advection and electrochemical reaction before exiting at an outlet. It will also be appreciated that each fluid channel in the tubular reactor can have at least one inlet and at least one outlet.

The reactor may comprise one or more chamber sections in fluid communication with each other. The static mixer electrode can be configured as a replaceable electrode for inserting into a continuous flow electrochemical reactor or configured as a permanent electrode. One or more reactors, or one or more chamber sections of a reactor, may be configured for series or parallel operation.

The length of the reaction chamber 102, separator 202 and electrodes 104, 106 may be in the range of 2 mm to 100 m, 10 mm to 10 m, 50 mm to 1 m, 100 mm to 500 mm, or 200 mm to 300 mm. The reactor housing or chamber may be between 5 mm and 5 m in diameter, with the counter and working electrodes sized so as to maintain an effective electrochemical arrangement. In some embodiments, the aspect ratio (L/d) of the reactor may be at least about 5, 10, 15, 20, 25, 30, 40, 50, 60, 75, or 100.

### Separator

The separator 202 may comprise any porous material that allows ionic transport but impedes fluid flow. The separator may comprise a permeable membrane, a semipermeable membrane or a selectively permeable membrane. In some embodiments, the separator 202 may be formed of any one or more of the following materials: nonwoven fibers (cotton, nylon, polyesters, glass), polymer films (polyethylene, polypropylene, poly (tetrafluoroethylene), polyvinyl chloride), ceramic and naturally occurring substances (rubber, asbestos, wood). In some embodiments, the separator 202 may include polymeric materials with pores of less than 20 Å. The separator 202 may be formed using dry and/or wet fabrication processes. Nonwoven separators 202 may comprise a manufactured sheet, web or mat of directionally or randomly oriented fibers.

In some embodiments, the separator 202 may comprise a supported liquid membrane, comprising solid and liquid phases contained within a microporous structure.

In some embodiments, the separator 202 may comprise polymer electrolytes that form complexes with alkali metal salts, which produce ionic conductors that serve as solid electrolytes. Solid ion conductors, can serve as both separator and the electrolyte.

The separator 202 may be formed of a single layer or multiple layers of material.

In some embodiments, the separator 202 may be made by sintering powdered material such as ceramics, glasses, plastics, cermets and combinations thereof into a membrane structure.

In some embodiments, the separator 202 may be configured to allow ions to pass through while impeding fluid flow. In some embodiments, the separator 202 may allow a small amount of fluid to pass through.

The separator 202 may have an inner diameter configured to closely fit around the first electrode 104. For example, the internal diameter of the separator 202 may be in the range of 0.5 mm to 5 m, 5 mm to 1 m, or 5 mm to 10 mm.

The thickness of the separator 202 may vary depending on its porosity. For nanoporous separators the thickness may be between 1 micron and 100 microns and for microporous membranes the thickness may be between 100 microns and 10 mm. The average pore size within the separator material may vary between 10 Å and 100 microns.

It will be appreciated that a permeable membrane generally establishes separate fluid channels for each of the static mixer electrode and the counter electrode while maintaining an electrical connection required for the electrochemical flow cell. The permeable membrane generally inhibits the flow of fluid through the membrane while permitting the transport of ions. For example, if during operation the static mixer electrode is operated as the negative electrode (i.e. cathode) and the counter electrode is operated as the positive electrode (i.e. anode), then a catholyte fluid stream for flowing across the static mixer electrode (i.e. cathode) can be prepared for a particular application that is different to an anolyte fluid stream for flowing across the positive counter electrode (i.e. anode). In other words, the permeable membrane permits ionic communication between the two electrodes to provide the electrical connection while separating the two individual fluid streams flowing past each of the cathode and anode, which provides performance advantages and process flexibility.

The permeable membrane may be concentrically located along the tubular reactor to separate the static mixer electrode from the counter electrode. The reactor can comprise an inner co-axial flow passage housing one electrode and an outer concentric flow passage housing the other electrode. A static mixer electrode can be housed in the inner co-axial flow passage, outer concentric flow passage, or in both the inner co-axial flow passage and outer concentric flow passage. The flow passage may also be referred to herein as a fluid channel.

The separator may be a semi-permeable membrane. The semi-permeable membrane may be a porous tubular film, a porous ceramic filter tube or a porous plastic tube that closely surrounds the static mixer electrode. It will be appreciated that the semi-permeable membrane substantially restricts fluid passing through the membrane while enabling the transport of ions across the membrane to maintain an electrical communication between the separated static mixer electrode and the counter electrode.

The separator may be a selectively-permeable membrane. The selectively-permeable membrane can provide selectivity in what is permitted to be transported through the membrane, for example specific fluids or ions. It will be appreciated that the selectively-permeable membrane selectively restricts what can pass through the membrane while enabling the transport of specific ions across the membrane to maintain an electrical communication between the separated static mixer electrode and the counter electrode.

It will be appreciated that each separate flow passage is provided with at least one inlet and at least one outlet. Separate fluid streams can be provided for the inner co-axial flow passage and outer concentric flow passage. For example, a catholyte fluid stream may be provided for the inner co-axial flow passage housing the static mixer electrode and an anolyte fluid stream may be provided for the outer concentric flow passage housing the counter electrode. As previously described, the static mixer electrode may also be co-axially aligned substantially along the axis of the tubular reactor.

### Static Mixer Electrode

As discussed above, either the first electrode 104 or the second electrode 106 or both the first and second electrodes 104, 106 may comprise a static mixer portion defining a geometry to promote mixing of a fluid flowing through or around the static mixer portion. This may be referred to as a static mixer electrode or SME.

The reactor may comprise more than one static mixer electrode and/or more than one counter electrode. The counter electrode may also be provided by a static mixer electrode, for example the cathode and anode in the electrochemical flow reactor may be each provided by a separate static mixer electrode. The static mixer electrode can be concentrically housed within the inner co-axial flow passage and the counter electrode can be housed within the outer concentric flow passage.

It will be appreciated that the static mixer electrode may comprise an electrically conductive surface. The static mixer electrode may be operated as an anode or a cathode, which depends on the direction of current flow being applied. For an electrochemical flow cell, it will be generally understood that an anode is a positive electrode where oxidation occurs and electrons are released by a reactant, and the cathode is a negative electrode where reduction occurs and electrons are consumed by another reactant.

The static mixer electrode may be prepared from a material capable of providing current densities on either electrode in a range from 1 μA m⁻² to about 1000 A m⁻². The static mixer electrode or scaffold thereof may comprise an electrically conductive material, for example conductive carbon material such as graphite, glassy carbon or boron-doped diamond, metals, alloys or intermetallics as powders, sheets, rods or billets, semimetals or doped or low bandgap semiconductors, metal coated particles, conducting ceramics. The scaffold may alternatively be made from a non-electrically-conducting material and subsequently be coated with an electrical conductor. Non-conducting materials may be particulate non-conductors such as plastics, ceramics, glasses or minerals, thermosetting resins, thermoplastic resins and natural products such as rubber and wood. Electrically conducting coatings may be formed from metals, metal alloys, intermetallics, conducting compounds, or from any electrically conductive materials as described above.

The static mixer electrode may be produced by subtractive manufacturing using one or combinations of processing techniques such as milling, cutting, drilling, turning, spinning, bending and twisting, by casting, moulding or forging, by extrusion, by pressing, by microelectromechanical systems machining (MEMS), additive manufacturing processes, laser or e-beam welding, selective laser sintering, selective laser melting, direct metal laser sintering, laser engineered net shaping, material extrusion, sheet lamination, polymerization and photopolymerisation, material or binder jetting, and printing.

In some embodiments, the body or scaffold of the static mixer electrode may be electrically conductive, for example a metal or metal alloy, such as nickel, titanium or stainless steel. In some embodiments, a conductive coating may be applied to the electrode surface, for example a titanium scaffold coated with platinum. The coating may be formed from a metal, semimetal or doped or low bandgap semiconductor, a conducting ceramic or compound, a conducting form of carbon (e.g. graphite, graphene or doped carbon materials), a conducting polymer (e.g. polyaniline), or a combination thereof. The coating may be applied to the surface by one or more of the following: electrochemical processes, metal spraying, cold spraying, chemical or physical vapour deposition, dip coating, spray coating, spin coating, sintering or other thermal processing, or any such process that results in a thin layer of an appropriate material being applied.

The static mixer electrode can be configured for enhancing mixing including heat and mass transfer characteristics for redistributing fluid in directions transverse to the main flow, for example in radial and tangential or azimuthal directions relative to a central longitudinal axis of the static mixer electrode. In particular, the static mixer electrodes can be configured to enhance chaotic advection thereby reducing the limitations on reaction rates imposed by diffusion. The static mixer electrode may be configured to ensure as much surface area as possible is presented to the flow to facilitate electrochemical reactions and to improve flow mixing so that the reactant molecules contact surfaces of the static mixer electrode more frequently. The static mixer electrode may be provided with various geometric configurations or aspect ratios for correlation with particular applications. The static mixer electrode may be configured to enhance turbulence, mixing and mass transfer characteristics of fluid streams. The configurations may also be designed to enhance efficiency, degree of chemical or electrochemical reaction, or other properties such as pressure drop (whilst retaining predetermined flow rates), residence time distribution, or heat and mass transfer coefficients.

The static mixer electrode can comprise an electrically conductive integral scaffold defining a plurality of passage sections configured for enhancing mass transfer and chaotic advection, for example by splitting fluid streams flowing between each of the passage sections. A substantial part of the surface of the scaffold can be electrically conductive.

The static mixer electrode can be configured to extend coaxially along the length and transversely across the diameter of a flow passage. In one example, the envelope of static mixer electrode can be configured to extend coaxially along the length of the inner co-axial flow passage and transversely across the diameter of the inner co-axial flow passage to substantially occupy the inner co-axial flow passage.

The first electrode 104 may have an outer diameter configured to closely fit within the separator 202. For example, the external diameter of the first electrode 104 may be in the range of 0.5 mm to 5 m, 5 mm to 1 m, or 5 mm to 10 mm. In embodiments such as the flow cell 400 described in relation to FIGS. 4A to 4C, where the first and second electrodes are arranged concentrically and coaxially with each other, the internal diameter of the second electrode 106 may be in the range of 0.5 mm to 5 m, 5 mm to 1 m, or 10 mm to 20 mm.

A ratio between the internal diameter of the separator 202 and the internal diameter of the second electrode 106 may be in the range of 0.02 to 0.99, 0.1 to 0.9, 0.3 to 0.7, or 0.4 to 0.6, for example.

The electrically conductive integral scaffold of the static mixer electrode can comprise a contiguous network of solid electrically-conductive elements distributed throughout the inner co-axial flow passage and configured for inducing chaotic advection of the fluid flowing through the inner co-axial flow passage. The contiguous network of solid electrically-conducting elements can be provided by a lattice of interconnected segments configured to define a plurality of apertures for inducing chaotic advection of the fluid flowing through the inner co-axial flow passage.

The static mixer electrode may be provided in a configuration selected from one or more of the following general non-limiting example configurations:
open configurations with helices;
open configurations with blades;
corrugated-plates;
multilayer designs;
closed configurations with channels or holes;
interlocking networks of struts, asperities, undulations and protrusions.

In one embodiment, the scaffold of the static mixer electrode may be provided in a mesh configuration having a plurality of integral units defining a plurality of passages configured for facilitating mixing of the one or more fluidic reactants.

In another embodiment, the static mixer electrode may comprise a scaffold provided by a lattice of interconnected segments configured to define a plurality of apertures for promoting mixing of fluid flowing through the reactor chamber. The scaffold may also be configured to promote heat and mass transfer as well as fluid mixing.

In some embodiments, the static mixer electrode may be configured to enhance chaotic advection, and for example turbulent mixing, such as cross-sectional, transverse (to the flow) or localised turbulent mixing. The geometry of the static mixer electrode, or scaffold thereof, may be configured to change the localised flow direction or to split the flow more than a certain number of times within a given length along a longitudinal axis of the static mixer element, such as more than 100 m⁻¹, optionally more than 200 m⁻¹, optionally more than 400 m⁻¹, optionally more than 800 m⁻¹, optionally more than 1500 m⁻¹, optionally more than 2000 m⁻¹, optionally more than 2500 m⁻¹, optionally more than 3000 m⁻¹, optionally more than 5000 m⁻¹. The geometry or configuration of the static mixer electrode, scaffold thereof, may comprise more than a certain number of flow splitting structures within a given volume of the static mixer, such as more than 100 m⁻³, optionally more than 1000 m⁻³, optionally more than 1×10⁴ m⁻³, optionally more than 1×10⁶ m⁻³, optionally more than 1×10⁹ m⁻³, optionally more than 1×10¹⁰ m⁻³.

The geometry or configuration of the static mixer electrode, or scaffold thereof, may be configured to accompany a channel of a reactor cell, such as a tubular reactor. As previously described, it will be appreciated that the term “tubular” includes non-circular configurations, for example elliptical. The static mixer electrode, or scaffold thereof, may be formed from or comprise a plurality of segments. Some or all of the segments may be straight segments. Some or all of the segments may comprise polygonal prisms such as rectangular prisms, for example. The scaffold may comprise a plurality of planar surfaces. The straight segments may be angled relative to each other. Straight segments may be arranged at a number of different angles relative to a longitudinal axis of the scaffold, such as two, three, four, five or six different angles, for example. The static mixer electrode, or scaffold thereof, may comprise a repeated structure. The static mixer electrode, or scaffold thereof, may comprise a plurality of similar structures repeated periodically along the longitudinal axis of the scaffold. The geometry or configuration may be consistent along the length of the static mixer electrode, or scaffold thereof. The geometry may vary along the length of the static mixer electrode, or scaffold thereof. The straight segments may be connected by one or more curved segments. The static mixer electrode, or scaffold thereof, may comprise one or more helical segments. The static mixer electrode, or scaffold thereof, may generally define a helicoid. The static mixer electrode, or scaffold thereof, may comprise a helicoid including a plurality of apertures in a surface of the helicoid.

The dimensions of the static mixer electrode may be varied depending on the application. The static mixer electrode, or reactor comprising the static mixer electrode, may be tubular. The static mixer electrode or reactor tube may, for example, have a diameter (in mm) in the range of 1 to 5000, 2 to 2500, 3 to 1000, 4 to 500, 5 to 150, or 10 to 100. The static mixer electrode or reactor tube may, for example, have a diameter (in mm) of at least about 1, 5, 10, 25, 50, 75, 100, 250, 500, or 1000. The static mixer electrode or reactor tube may, for example, have a diameter (in mm) of less than about 5000, 2500, 1000, 750, 500, 250, 200, 150, 100, 75, or 50. The aspect ratios (L/d) of the static mixer electrode, or reactor chambers comprising the static mixer electrode, may be provided in a range suitable for industrial scale flow rates for a particular reaction. The aspect ratios may, for example, be in the range of about 1 to 1000, 5 to 750, 10 to 500, 25 to 250, 50 to 150, or 75 to 125. The aspect ratios may, for example, be less than about 1000, 750, 500, 250, 200, 150, 125, 100, 75, 50, 25, 20, 15, 10, 9, 8, 7, 6, 5, 4, 3, or 2. The aspect ratios may, for example, be greater than about 1, 2, 3, 4, 5, 6, 7, 8, 9, 10, 15, 20, 25, 30, 35, 40, 45, 50, 55, 60, 65, 70, 75, 80, 85, 90, 95, or 100. The aspect ratios may be provided in a range of any two of the above “less than” and “greater than” values.

The static mixer electrodes may be configured for enhancing properties, such as mixing and heat and mass transfer, for laminar flow rates or turbulent flow rates. It will be appreciated that for Newtonian fluids flowing in a hollow pipe, the correlation of laminar and turbulent flows with Reynolds number (Re) values would typically provide laminar flow rates where Re is <2300, transient where 2300<Re <4000, and generally turbulent where Re is >4000. It will be appreciated that the static mixer electrodes reduce these typical Re values for producing turbulent flow. The static mixer electrodes may be configured for laminar or turbulent flow rates to provide enhanced properties selected from one or more of mixing, degree of reaction, heat and mass transfer, chaotic advection, and pressure drop. It will be appreciated that further enhancing a particular type of electrochemical reaction will require its own specific considerations. For flow in a tube, the Reynolds number can be defined as Re=ρuD_{H}/μ (ρ is the density of a fluid in kg.m⁻³, u is the mean velocity of the fluid m.s⁻¹, D_{H} is the hydraulic diameter of the pipe in meters, and μ is the dynamic viscosity of the fluid in Pa·s).

In one embodiment, the static mixer electrode may be configured for operating at a Re of at least 0.01, 0.1, 1, 5, 50, 100, 150, 200, 250, 300, 350, 400, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, 8000, 8500, 9000, 9500, 10000, 11000, 12000, 13000, 14000, or 15000. The static mixer electrode may be configured for operating in a Re range of about 0.1 to 2000, 1 to 1000, 10 to 800, or 20 to 500. The static mixer electrode may be configured for operating in a Re range of about 1000 to 15000, 1500 to 10000, 2000 to 8000, or 2500 to 6000. The static mixer electrode may be configured for operating at a Re in a range between any two of the above described “at least” values.

In some embodiments, the static mixer electrode may be described by the Péclet number (Pe), which is another class of dimensionless numbers relevant to transport phenomena in a continuum. The Péclet number provides a ratio of the rate of advection of a physical quantity by the flow to the rate of diffusion of the same quantity driven by an appropriate gradient. In the context of species or mass transfer, the Péclet number is the product of the Reynolds number (Re) and the Schmidt number (Sc). In the context of thermal fluids, the thermal Péclet number is equivalent to the product of the Reynolds number (Re) and the Prandtl number (Pr).The Péclet number is defined as: Pe=advective transport rate/diffusive transport rate. For mass transfer, it is defined as: Pe_{L}=Lu/D=Re_{L}.Sc. For heat transfer, it is defined as PeL=Lu/α=Re_{L}.Pr, where α=k/ρcₚ. L is the characteristic length, u the local flow velocity, D the mass diffusion coefficient, and α the thermal diffusivity, ρ the density, and cₚ the heat capacity. The static mixer electrode can be configured to provide higher Péclet values to enhance chaotic advection over diffusion to provide a more uniform residence time distribution and reduce dispersion. In other words, configuration of the static mixer electrode to provide higher Péclet values can, at least according to some embodiments and examples as described herein, provide improved performance and process control.

In one embodiment, the static mixer electrode may be configured for operating at a Péclet (Pe) value of at least 100, 1000, 2000, 5000, 10000, 15000, 20000, 25000, 50000, 75000, 100000, 250000, 500000, 10⁶, or 10⁷. The static mixer electrode may be configured for operating at a Péclet (Pe) value of less than about 10⁸, 10⁷, 10⁶, 500000, 250000, 100000, 75000, 50000, 25000, 20000, 15000, 10000, 5000, 2000, or 1000. The static mixer element may be configured for operating in a Pe range of about 10³ to 10⁸, 10³ to 10⁷, or 10⁴ to 10⁶. The static mixer element may be configured for operating in a Pe range between any two of the above upper and/or lower values.

The volume displacement % of the static mixer electrode relative to flow passage housing the electrode may be in the range of about 1 to 90, 5 to 70, 10 to 30, or 5 to 20. The volume displacement % of the static mixer electrode relative to flow passage housing the electrode may be less than 90%, 80%, 70%, 60%, 50%, 40%, 30%, 20%, 10%, or 5%. The volume displacement % of the static mixer electrode relative to the flow passage housing the electrode may be greater than 1%, 5%, 10%, 15%, 20%, 25%, 30%, 35%, 40%, 50%, 60%, 70% or 80%. The volume displacement % may be provided in a range of any two of the above “less than” and “greater than” values.

The configurations of the static mixer electrode may be provided to enhance heat and mass transfer properties in the reactor, for example a reduced temperature differential at the exit cross-section. The heat and mass transfer of the static mixer electrode may, for example, provide a cross-sectional or transverse temperature profile that has a temperature differential of less than about 20° C./mm, 15° C./mm, 10° C./mm, 9° C./mm, 8° C./mm, 7° C./mm, 6° C./mm, 5° C./mm, 4° C./mm, 3° C./mm, 2° C./mm, or 1° C./mm.

The static mixer electrode or scaffold thereof may be configured such that, in use, the pressure drop (i.e. pressure differential or back pressure) across the static mixer electrode (in Pa/m) is in a range of about 0.1 to 1,000,000 Pa/m (or 1 MPa/m), including at any value or range of any values there between. For example, the pressure drop across the static mixer electrode (in Pa/m) may be less than about 500,000, 250,000, 100,000, 50,000, 10,000, 5,000, 1,000, 750, 500, 250, 100, 75, 50, 25, 20, 15, 10, or 5 Pa/m. For example, the pressure drop across the static mixer electrode (in Pa/m) may be at least about 10, 100, 1000, 5,000, 10,000, 50,000, 100,000, or 250,000. The pressure drop across the static mixer electrode (in Pa/m) may be provided in a range of any two of the above upper and/or lower values. For example, in one embodiment the pressure drop across the static mixer electrode (in Pa/m) may be in the range of between about 10 and 250,000, 100 and 100,000, or 1,000 and 50,000. The static mixer electrode may be configured to provide a lower pressure drop relative to a specific flow rate. In this regard, the static mixer electrode, reactor, system, and processes, as described herein, may be provided with parameters suitable for industrial application. The above pressure drops may be maintained where the volumetric flow rate is at least 0.1, 0.5, 1, 1.5, 2, 2.5, 3, 3.5, 4, 4.5, 5, 6, 7, 8, 9, 10, 20, 30, 40, 50 ml/min.

In one embodiment, the static mixer electrodes may be configured to operate with a volumetric flow rate of at least 0.1, 0.5, 1, 1.5, 2, 2.5, 3, 3.5, 4, 4.5, 5, 6, 7, 8, 9, 10, 20, 30, 40, 50, 75, 100, 125, 150, 200, 250, 300, 350, 400, 450, 500, 600, 700, 800, 900, or 1000 ml/min. In another embodiment, the volumetric flow rate may be less than about 1000, 900, 800, 700, 600, 500, 450, 400, 350, 300, 250, 200, 150, 100, 75, 50, 40, 30, 20, 10, or 5 ml/min. The flow rate may be a range provided by any two of these upper and/or lower values, for example a range between about 50 and 400, 10 and 200, or 20 and 200.

The static mixer electrode may be configured as a modular insert for a continuous flow electrochemical reactor or chamber thereof. The static mixer electrode may be configured for use with an in-line continuous flow electrochemical reactor or chamber thereof. The in-line continuous flow electrochemical reactor may be a recycle loop reactor or a single pass reactor.

The configuration of the static mixer electrode may be determined using Computational Fluid Dynamics (CFD) software, which can be used for enhancing the configuration for mixing of reactants for enhanced contact and activation of the reactants at the surface of the static mixer electrode.

The static mixer electrode may be an additive manufactured static mixer electrode. Additive manufacturing of the static mixer electrode, optionally with catalytic and/or corrosion resistant coatings, can provide a static mixer electrode configured for efficient mixing, heat and mass transfer, electrochemical reaction, or additional catalytic reaction. The additive manufacture process allows the static mixer electrode to be physically tested for reliability and performance, and optionally further re-designed and re-configured using additive manufacturing (e.g. 3D printing) technology. Additive manufacturing provides flexibility in preliminary design and testing, and further re-design and re-configuration of the static mixer electrodes. An electron beam 3D printer or a laser beam 3D printer may be used. The additive material for the 3D printing may be, for example, pure metal, such as iron, cobalt, nickel, copper, zinc or an alloy such as titanium alloy-based powders (e.g. 45-105 micrometre diameter range), cobalt-chrome alloy-based powders (e.g. FSX-414 or Stellite S21) or stainless steel or aluminium-silicon alloy or any of the nickel-based alloys (e.g., Inconel, Hastelloy). The powder diameters associated with the laser beam printers are typically lower than those used with electron beam printers. Alternatively, the scaffold may be additively manufactured from an inert material such as plastic or glass and then coated with a suitable electrically conducting material. In addition to the electrically conducting surface, the static mixer electrode or scaffold thereof, may optionally further comprise catalytic materials, depending on the particular reaction or application required.

### Counter Electrode

It will be appreciated that the counter electrode is electrically conductive. The counter electrode may be operated as an anode or a cathode, which depends on the direction of current flow being applied. The counter electrode may be composed of material or configured according to any embodiments or examples as described above for the static mixer electrode.

It will be appreciated that the counter electrode may comprise an electrically conductive surface. The counter electrode may be prepared from a material capable of providing current densities on either electrode in a range from 1 μA m⁻² to about 1000 A m⁻². The counter electrode may comprise an electrically conductive material, for example conductive carbon material such as graphite, glassy carbon or boron-doped diamond, metals, alloys or intermetallics as powders, sheets, rods or billets, semimetals or doped or low bandgap semiconductors, metal coated particles, conducting ceramics. The counter electrode may be made from a non-electrically-conducting material and coated with an electrical conductor. Non-conducting materials may be particulate non-conductors such as plastics, ceramics, glasses or minerals, thermosetting resins, thermoplastic resins and natural products such as rubber and wood. Electrically conducting coatings may be formed from metals, metal alloys, intermetallics, conducting compounds, or from any electrically conductive materials as described above for the counter electrode or static mixer electrode.

### Reactor and Endcap Configuration

The reactor may be provided as an assembly comprising the reactor housing, first electrode, second electrode, separator, and one or two optional endcaps. The endcaps can be configured to seal the reactor housing, and further optionally configured for association with one or more of the first electrode, second electrode, separator, for structural and alignment support in assembling and operation of the reactor.

In an embodiment, the tubular reactor may comprise a first and second end cap, the first and second end caps each cooperatively configured for securing opposite ends of the reactor housing and supporting the arrangement in the reactor of the static mixer electrode, the counter electrode and separator.

The end caps may be an integral part of the static mixer electrode and/or counter electrode (e.g. the end caps can be made as part of one of the electrode). The end caps may be provided as an integral part of the electrochemical flow cell or continuous flow electrochemical tubular reactor (e.g. the entire electrochemical flow cell is made by additive manufacture).

The end caps may be provided according to any other embodiments or examples thereof as described herein.

### Electrochemical Flow System

A system for providing a continuous flow electrochemical reaction can comprise an electrochemical flow cell, or electrochemical tubular reactor, according to any one or more aspects, embodiments or examples as described herein.

The system can further comprise a pump for providing fluidic flow for one or more fluidic reactants and any products thereof through the reactor. The system can further comprise an electric unit for providing and controlling electrical voltage applied to, or current flowing through the electrodes for driving the electrochemical reaction at the interface of the fluid stream and electrodes. The system can further comprise a controller for controlling one or more of the parameters of the system selected from concentration, flow rate, temperature, pressure, and residence time, of the one or more fluidic reactants, or sources or products thereof.

The reactor system may comprise one flow cell assembly, or multiple assemblies set up in parallel or in series. The polarities of the electrodes in each setup may be connected the same way in each cell or in an alternating manner wherein the outer electrodes are alternatively anode, cathode, anode, cathode . . . (or vice versa) and the inner electrode are alternatively cathode, anode, cathode, anode . . . (or vice versa). The system may be set up in any combination of these polarities. The magnitudes of the voltages or currents applied to each cell in the system may be identical or may vary and the pumping speeds through the cells in the system may be identical or may vary.

The reactor system may be constructed and controlled so as to accept time-varying power input, for example from a renewable energy source. For example, reactant flow rates may be varied according to the power available for electrolysis, so the flow reactor keeps operating when the power source fluctuates.

The aspect ratios of the reactor may, for example, be similar to those previously described for the static mixer electrode such that a static mixer electrode module may be configured for insertion into the reactor.

The reactor can comprise an optional heat exchanger for controlling the temperature of the reactor, chamber section, static mixer, or fluidic components thereof. The heat exchanger may be a shell and tube heat exchanger design or configuration.

The present disclosure also provides a system for a continuous flow electrochemical reaction process comprising:

a continuous flow electrochemical reactor comprising one or more static mixer electrodes according to any of the embodiments or examples as described herein;

a pump for providing fluidic flow for one or more fluidic reactants and any products thereof through the reactor;

a control means for controlling one or more of the parameters of the system selected from reactant concentrations, flow rates, current flow, applied voltage, pressure, and residence time.

The system can comprise an optional heat exchanger for controlling the temperature of the reactor or fluidic components thereof.

The system may further comprise a spectrometer, which can be used for identifying and determining concentrations for any one or more fluidic reactants or products thereof.

One or more of the reactor, reactor chamber, chamber section and static mixer electrode, may each be provided in modular form for complimentary association thereof. The system may comprise a plurality of reactors, which may be of similar or different internal and/or external configuration. The reactors may operate in series or in parallel, or in a combination of both. It will be appreciated that the system, reactor, or each chamber section, may include one or more inlets and outlets to provide supply of reactants, obtain products, or to recirculate various reactants and/or products.

It will also be appreciated that the reactor or system may be designed for recycling of the various reactants, reactant sources, intermediary products, or desired products provided to and produced in the chamber sections. The reactor or system may be provided in various designs and forms, for example in the form of a tubular reactor. In another embodiment, the reactor is a single pass reactor.

The system and processes may also be integrated into more complex systems, such as systems and processes comprising a coal gasifier, water purification and reticulation, electrolyser and/or natural gas reformer, chemical synthesis and purification, etc.

### Electrochemical Applications

The electrochemical flow reactor, electrochemical flow cell, or continuous flow electrochemical tubular reactor, according to any embodiments or examples as described herein, may be used for various applications including metal recovery, heavy and precious metal recovery from effluent and mine wastewater, wastewater treatment, water disinfection or purification (e.g. drinking water), and recovery of metals from solid wastes (e.g. sludge, tailings and disposed products), and electrosynthesis of various products. (e.g. gas generation, energy storage and conversion, reagent regeneration, and polymerization).

The reactor comprising the static mixer electrode may be for use in a continuous flow electrochemical reaction system and process. The process may be an in-line continuous flow process. The in-line continuous flow process may be a recycle loop or a single pass process. In one embodiment, the in-line continuous flow process is a single pass process.

As mentioned above, the electrochemical reactor comprising the static mixer electrode is capable of performing reactions in a continuous fashion. The electrochemical reactor may use single or multi-phase feed and product streams. In one embodiment, the substrate feed (comprising one or more reactants) may be provided as a continuous fluidic stream, for example a liquid stream containing either: a) the substrate as a solute within an appropriate solvent, or b) a liquid substrate, with or without a co-solvent. It will be appreciated that the fluidic stream may be provided by one or more gaseous streams, for example a hydrogen gas or source thereof. The substrate feed is pumped into the reactor using pressure driven flow, e.g. by means of a pump. In another embodiment the substrate feed may be provided by solids suspended in a fluid stream, and in yet another embodiment the reactant fluid stream may comprise solids, liquids and gases.

In one embodiment, there is provided a method for electrochemical treatment of a fluid stream comprising an electrochemical flow cell or continuous flow electrochemical tubular reactor according to any embodiments or examples thereof as described herein.

The above method may be for removing dissolved metal ions from a fluidic stream by applying a direct current across the static mixer electrode and counter electrode to form a solid deposit comprising metals and/or metallic compounds on the surface of the static mixer electrode. The method may be for the recovery of metal from a fluidic stream obtained from mine tailings. The method may comprise operating in parallel and/or series as described above for the reactor system. In an embodiment, the method is operated in series.

In one example, the method comprises at least a first and second continuous flow electrochemical tubular reactor, each reactor configured so that the permeable membrane separates the static mixer electrode from the counter electrode to define an inner co-axial flow passage housing one electrode and an outer concentric flow passage housing the other electrode, each flow passage having at least one inlet and at least one outlet. The method can enable loading of metal onto a static mixer electrode of the first tubular reactor while providing the second reactor in series with polarity of electrodes reversed to remove metal previously loaded onto a static mixer electrode of the second tubular reactor.

In a further example of this above method, a first fluid stream can be introduced into the inner co-axial flow passage of the first tubular reactor and the output thereof introduced into the outer concentric flow passage of the second tubular reactor. A second fluid stream can be concurrently introduced into the outer concentric flow passage of the first tubular reactor and the output thereof introduced into the inner co-axial flow passage of the second tubular reactor. The first tubular reactor can be operated to have the first static mixer electrode under reduction to accumulate solid metallic species and the second tubular reactor operated to have the second static mixer electrode under oxidation to remove any metal species present thereon.

Another advantage of the electrochemical flow reactor and system thereof according to various embodiments or examples as described herein is that the electrochemical flow cell or tubular reactor does not need to be dissembled and cathode replaced, and provides flexibility to operate in series or with reverse mode by switching current and switching in different fluidic streams to remove metal, metallic compounds or other metal containing products formed on static mixer electrode as the cathode in a reduction reaction.

The present disclosure also provides a process for synthesizing a product by reaction of one or more fluidic reactants, the process comprising the steps of:

providing a continuous flow electrochemical reactor comprising a static mixer electrode or system according to any of the embodiments or examples described herein;

providing at least a first fluidic reactant to the reactor via a reactant inlet;

operating the reactor, or control means thereof, to provide flow and reaction of the at least first fluidic reactant through the static mixer electrode; and

obtaining an output stream comprising a product of a reaction of the at least first reactant.

It will be appreciated that various parameters and conditions used in the process, such as current flow, pressures and concentration/amounts of materials and reactants, may be selected depending on a range of variables of the process including the product to be synthesised, electrochemical reaction or mechanisms involved, reactant source, or type of reactor being used and materials and configuration thereof. For example, differences will exist where the one or more fluidic reactants, or co-solvents (e.g. inert carriers) etc., are gases, liquids, solids, or combinations thereof.

The electrochemical flow reactor can be operated with current densities on either electrode in a range from 1 μA m⁻² to about 1000 A m⁻². The current density (in A m⁻²) may, for example, be less than about 1000, 500, 200, 100, 50, 20, 10, 5.0, 2.0, 1.0, 0.5, 0.2, 0.1, 0.05, 0.02, 0.01, 0.005, 0.002, 0.001, 0.0005, 0.0002, 0.0001, 0.00005, 0.00002, 0.00001, 0.000005, 0.000002, or 0.000001. The current density (in A m⁻²) may, for example, be greater that about 0.000002, 0.000005, 0.00001, 0.00002, 0.00005, 0.0001, 0.0002, 0.0005, 0.001, 0.002, 0.005, 0.01, 0.02, 0.05, 0.1, 0.2, 0.5, 1.0, 2.0, 5.0, 10, 20, 50, 100, 200, or 500. The current density may be provided in any range of two values selected from any of the above values. It will be appreciated that various applications and configurations may apply different current densities.

In some examples, the voltages applied across the electrodes may be less than about 2.0, 1.8, 1.6, 1.4, 1.2, 1.0, 0.8, 0.6, 0.4, or 0.2. In some examples, the voltages applied across the electrodes may be at least about 0.2, 0.4, 0.6, 0.8, 1.0, 1.2, 1.4, 1.6, or 1.8. The voltages may be in a range provided by any two of these upper and/or lower values.

In one example, the operational performance of the electrochemical flow reactor may be measured by its recovery efficiency. Recovery efficiency involves the amount of a species (e.g. contaminant), such as a dissolved metal species, present in a fluid that may be removed from the fluid by the electrochemical flow cell. In one example, the recovery efficiency measured as a % of contaminant recovered (or removed) from a fluid is at least 5, 10, 15, 20, 25, 30, 35, 40, 45, 50, 55, 60, 65, 70, 75, 80, 85, 90, 95, 96, 97, 98, or 99. In some examples, any of the recovery efficiencies may be provided from continuous operation (e.g. recycling in recycle loop reactor) over a duration of less than about 48 hours, 36 hours, 24 hours, 12 hours, 6 hours, 3 hours, 2 hours, or 1 hour. In another example, a species (e.g. contaminant), such as a dissolved metal species (e.g. copper species), may be removed from a fluid where the species is present in the fluid at a concentration of less than about (in mol/L) 1, 0.5, 0.1, 0.05, 0.01, 0.005, 0.001, 0.0005, 0.0001, 0.00005, or 0.00001. In another example, a species (e.g. contaminant), such as a dissolved metal species, may be removed from a fluid where the species is present in the fluid at a concentration of more than about (in mol/L) 0.0001, 0.0005, 0.001, 0.005, 0.01, 0.05, 0.1, or 0.5. The species removed may be at a concentration between any two of these upper and/or lower ranges. The above recovery efficiencies and/or recycling durations may apply to any of these species (e.g. contaminant) concentrations. For example, the operational performance of the reactor, system or methods thereof, may provide a recovery efficiency of at least about 50% of a dissolved metal species from a fluid having an initial concentration of less than about 0.01 mol/L. In another example, the recovery efficiency may be at least about 60% of a dissolved metal species from a fluid having an initial concentration of less than about 0.005 mol/L. In another example, the recovery efficiency may be at least about 70% of a dissolved metal species from a fluid having an initial concentration of less than about 0.001 mol/L. In another example, the recovery efficiency may be at least about 80% of a dissolved metal species from a fluid having an initial concentration of less than about 0.0005 mol/L. In another example, the recovery efficiency may be at least about 90% of a dissolved metal species from a fluid having an initial concentration of less than about 0.0001 mol/L.

In another example, a species (e.g. contaminant), such as a dissolved metal species (e.g. copper species), may be removed from a fluid where the species is present in the fluid at an initial concentration of about or less than about (in ppm) 1000, 750, 500, 250, 100, 75, 50, 25, 10, 5, or 1. In another example, a species (e.g. contaminant), such as a dissolved metal species, may be removed from a fluid where the species is present in the fluid at an initial concentration of about or more than about (in ppm) 5, 10, 25, 50, 75, 100, 250, 500, 750, or 1000. The species removed may be at an initial concentration in the fluid between any two of these upper and/or lower ranges. In one example, the recovery efficiency measured as a % of contaminant recovered (or removed) from a fluid is at least 5, 10, 15, 20, 25, 30, 35, 40, 45, 50, 55, 60, 65, 70, 75, 80, 85, 90, 95, 96, 97, 98, or 99. In some examples, any of the recovery efficiencies may be provided from a continuous operation (e.g. recycling in recycle loop reactor) over a duration of less than about 48 hours, 36 hours, 24 hours, 12 hours, 6 hours, 3 hours, 2 hours, or 1 hour. The above recovery efficiencies and/or recycling durations may apply to any of these species (e.g. contaminant) concentrations. For example, the operational performance of the reactor, system or methods thereof, may provide a recovery efficiency of at least about 50% of a dissolved metal species from a fluid having an initial concentration of about 100 ppm of the dissolved metal species during a continuous operation of less than about 3 hours. In another example, the recovery efficiency may be at least about 95% of a dissolved metal species from a fluid having an initial concentration of about 100 ppm during a continuous operation of less than about 24 hours.

Temperatures (° C.) in relation to the process may be in a range between −50 and 400, or at any integer or range of any integers there between. For example, the temperature (° C.) may be at least about −50, −25, 0, 25, 50, 75, 100, 150, 200, 250, 300, or 350. For example, the temperature (° C.) may be less than about 350, 300, 250, 200, 150, 100, or 50. The temperature may also be provided at about any of these values or in a range between any of these values, such as a range between about 0 to 250° C., about 25 to 200° C., or about 50 to 150° C.

In one embodiment, the process may be operated to provide an Re of at least 0.01, 0.1, 1, 5, 50, 100, 150, 200, 250, 300, 350, 400, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, 8000, 8500, 9000, 9500, 10000, 11000, 12000, 13000, 14000, or 15000. The process may be operated at an Re range of about 0.1 to 2000, 1 to 1000, 10 to 800, or 20 to 500. The process may be operated at an Re range of about 1000 to 15000, 1500 to 10000, 2000 to 8000, or 2500 to 6000. The process may be operated at an Re range provided by any two of the above “at least” values.

In one embodiment, the process may be operated at a Péclet (Pe) value of at least 100, 1000, 2000, 5000, 10000, 15000, 20000, 25000, 50000, 75000, 100000, 250000, 500000, 10⁶, or 10⁷. The process may be operated at a Péclet (Pe) value of less than about 10⁸, 10⁷, 10⁶, 500000, 250000, 100000, 75000, 50000, 25000, 20000, 15000, 10000, 5000, 2000, or 1000. The process may be operated at a Pe range of about 10³ to 10⁸, 10³ to 10⁷, or 10⁴ to 10⁶. The process may be operated at a Pe range between any two of the above upper and/or lower values.

The process may provide a pressure drop (or back pressure) across the static mixer electrode (in Pa/m) in a range of about 0.1 to 1,000,000 Pa/m (or 1 MPa/m), including at any value or range of any values therebetween. For example, the pressure drop across the static mixer electrode (in Pa/m) may be less than about 500,000, 250,000, 100,000, 50,000, 10,000, 5,000, 1,000, 750, 500, 250, 100, 75, 50, 25, 20, 15, 10, or 5 Pa/m. For example, the pressure drop across the static mixer electrode (in Pa/m) may be at least about 10, 100, 1000, 5,000, 10,000, 50,000, 100,000, or 250,000. The pressure drop across the static mixer electrode (in Pa/m) may be provided in a range of any two of the above upper and/or lower values. For example, in one embodiment the pressure drop across the static mixer electrode (in Pa/m) may be in the range of between about 10 and 250,000, 100 and 100,000, or 1,000 and 50,000. In this regard, the static mixer electrode, reactor, system, and processes, as described herein, may be provided with parameters suitable for industrial application. The above pressure drops, or ranges thereof, may be provided where the volumetric flow rate is at least 0.1, 0.5, 1, 1.5, 2, 2.5, 3, 3.5, 4, 4.5, 5, 6, 7, 8, 9, 10, 20, 30, 40, 50, 100, 500, 1000 ml/min.

In one embodiment, a volumetric flow rate may be provided of at least 0.1, 0.5, 1, 1.5, 2, 2.5, 3, 3.5, 4, 4.5, 5, 6, 7, 8, 9, 10, 20, 30, 40, 50, 75, 100, 125, 150, 200, 250, 300, 350, 400, 450, 500, 600, 700, 800, 900, or 1000 ml/min. In another embodiment, the volumetric flow rate may be provided of less than about 1000, 900, 800, 700, 600, 500, 450, 400, 350, 300, 250, 200, 150, 100, 75, 50, 40, 30, 20, 10, or 5 ml/min. The flow rate may be a range provided by any two of these upper and/or lower values, for example a range between about 50 and 400, 10 and 200, or 20 and 200.

The process may involve a mean residence time in the static mixer or reactor in a range of about 0.1 second to about 60 minutes. The mean residence time may, for example, be less than about 60 minutes, 45 minutes, 30 minutes, 15 minutes, 10 minutes, 5 minutes, 1 minute, 30 seconds, 10 seconds, or 5 seconds. The mean residence time may, for example, be greater than about 1 second, 5 seconds, 10 seconds, 30 seconds, 1 minute, 5 minutes, 10 minutes, 15 minutes, 30 minutes, or 45 minutes. The mean residence time may be provided as a range selected from any two of these previously mentioned values. For example, the mean residence time may be in a range of 5 seconds to 10 minutes, 1 second to 5 minutes, or 1 minute to 60 minutes.

The process may provide a Faradaic efficiency (% charge passed that takes part in the reaction of interest) of at least 5, 10, 15, 20, 25, 30, 35, 40, 45, 50, 55, 60, 65, 70, 75, 80, 85, 90, 95, 98, or 99. The process may provide a Faradaic efficiency (% charge passed that takes part in the reaction of interest) of less than 99, 98, 95, 90, 85, 80, 75, 70, 65, 60, 55, 50, 45, 40, 35, 30, 25, 20, 15, or 10. The process may provide a Faradaic efficiency (% charge passed that takes part in the reaction of interest) in a range provided by any two of the above upper and/or lower values.

The anolyte and/or catholyte streams may include any suitable solvent, electroactive species and supporting electrolyte. The concentrations of the dissolved species may vary from parts per billion to the limits of their solubility (tens of moles per litre). In addition to dissolved species, the fluidic streams may also contain multiple phases in any combination: undissolved solids (e.g. solids suspended in a fluidic stream), immiscible liquids and gases. Thus, the fluidic streams may comprise aqueous or non-aqueous solvents, molecular solvents, molten salts, ionic liquids, supercritical solvents or mixtures of these. The dissolved species may be ionic, molecular or substantially ion-paired in solution. They may be dissolved solids, gases, miscible liquids, or mixtures therefrom. The other phases present may be suspended solids or gels, organic or inorganic polymers, natural products or mixtures of these. They may be gases or vapours deliberately introduced or produced by the action of flow and/or electrochemical activity. In another example, the fluid is a liquid or a complex liquid, such as a liquid comprising a dissolution and/or suspension of solids.

In an embodiment, there may be provided a method for removal of a species from a fluid stream comprising an electrochemical flow cell or system thereof according to any aspects, embodiments or examples thereof as described herein. The species may be a metal species dissolved in the fluid stream. It will be appreciated that any of the above embodiments or examples relating to performance of the electrochemical flow cell may apply to this embodiment.

### EXAMPLES

The present disclosure is further described by the following examples. It is to be understood that the following description is for the purpose of describing particular embodiments only and is not intended to be limiting with respect to the above description.

### Example 1

An electrochemical flow reactor was prepared comprising a separator 200 (FIG. 2), along with a liquid feed line including a peristaltic pump(s) (Masterflex L/S Variable-Speed Drive w/Remote I/O; 600 rpm) 120 to control the electrolyte flow into the cell and a power supply 110 (Autolab 302N potentiostat from Metrohm Autolab BV, Utrecht, The Netherlands) to control the applied electrochemical potential/current flowing through the cell.

An additively manufactured metallic static mixer electrode (SME) 104, 204 as the working electrode was closely fitted within a tubular porous polymeric separator 202 (GenPore Reading, USA) in the separated mode configuration which defines the working compartment. Two ports at either end of the electrode are incorporated into the design to provide connections for fluid flow. Fluid is admitted to the working compartment through these tubes. As with all static mixers, the momentum of the solution induces mixing as it flows past the many angled faces of the mixer surface. An inert tubular counter electrode 102, made of glassy carbon in this particular experiment, surrounds the working compartment at a small distance from the separator, creating a low volume counter compartment and formed the outside casing of the cell. The whole assembly is sealed using two end caps 500 (FIGS. 4a, 4b and 4c). Ports 144 machined into the end caps provide fluid flow into the counter electrode compartment. This configuration allows for different fluids to be used in the two compartments if required by the experiment.

The efficiency with which the cell works may be evaluated by comparing the limiting current measured at various flow rates with results from a Rotating disk electrode (RDE) in the same solution. These comparisons are useful indicators of performance, and are not used to draw any conclusions about the hydrodynamic conditions at the static mixer surface.

To evaluate performance of the two configurations of the present electrochemical flow reactor, a series of experiments were conducted investigating the electrochemical reduction of ferricyanide ([Fe(CN)₆]³⁺) solution (10⁻³-10⁻¹ M) in 0.5 M potassium chloride as supporting electrolyte using platinum coated static mixer electrode (i.e. working electrode) and glassy carbon tube (i.e. anode). A typical reduction reaction on the separated configuration of the reactor was conducted as follows.

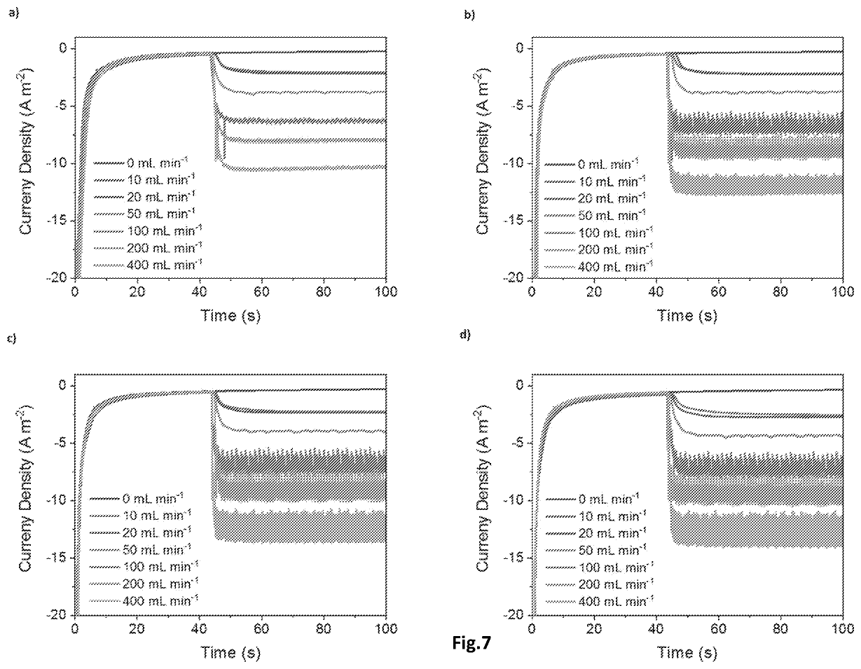

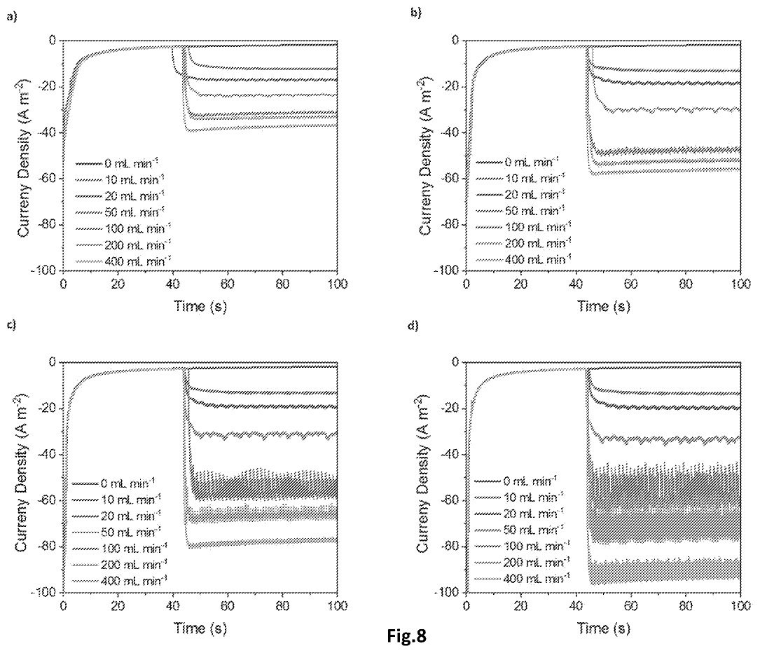

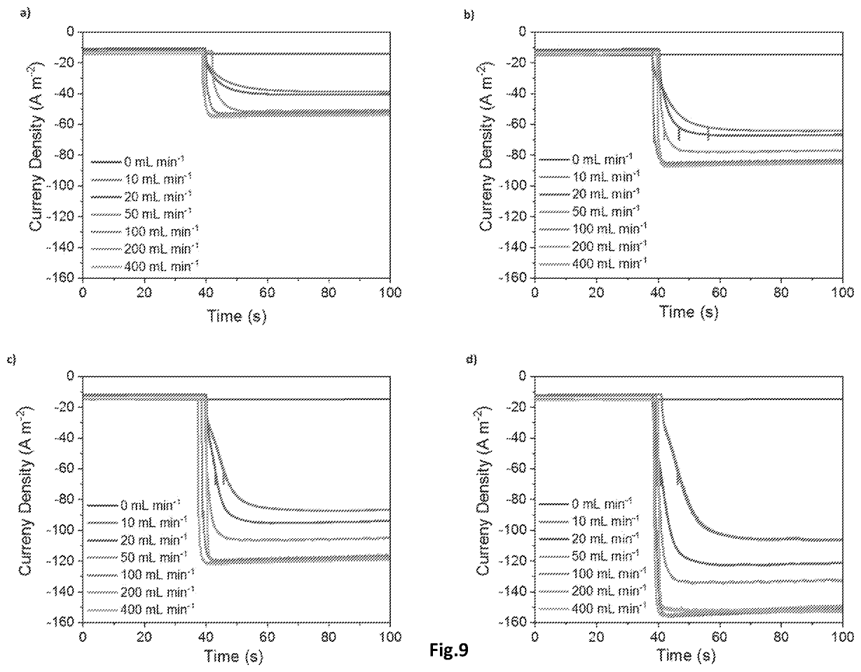

Chronoamperometric measurements were conducted at potential steps of −1.4 V, −1.6 V, −1.8 V and −2 V were applied to the cell over 100 seconds, with the cell operated for the first 50 seconds interval in stationary mode (i.e. 0 mL min') and the last 50 seconds interval at a constant flow rate between 10 and 400 mL min⁻¹ (FIGS. 7-9). Steady-state currents were observed for all flow rates and by increasing the flow rate, the current recorded increased in all potential steps. Although the currents recorded increased with increasing potential, some gas bubbles were observed in the solution exiting the flow cell when −1.8 V and −2 V were applied. At these higher potentials for this experimental set-up hydrogen evolution in addition to [Fe(CN)₆]³⁺ reduction occurs at the cathode which can complicate the analysis.

The experimental results showed that at lower concentrations of electroactive ions where the reaction is limited by mass transport (i.e. 0.001 and 0.01 M of [Fe(CN)₆]³⁺), the electrochemical flow cell configuration significantly enhances the reaction rate. At the higher concentration (i.e. 0.1 M [Fe(CN)₆]³⁺) where the reaction is controlled by mass transport and kinetic factors (mixed control) the enhancement to the reaction rate is smaller, between 1.5 to 3.7 faster when using the static mixer electrode.

### Example 2

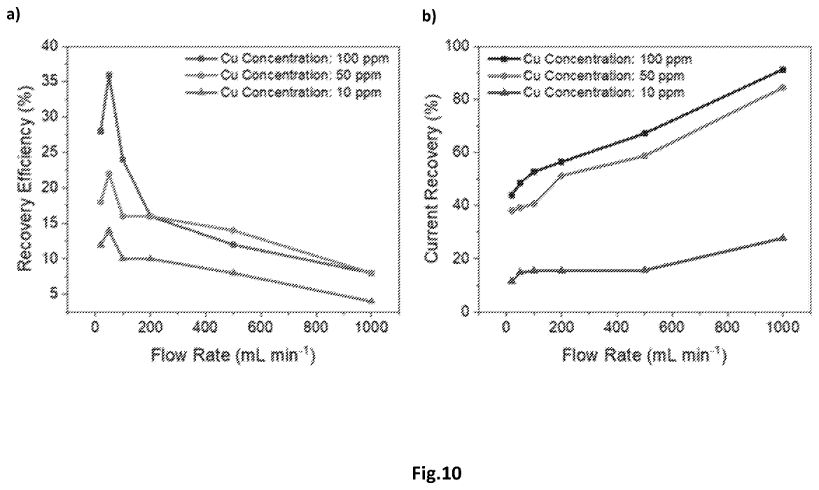

The efficiency of the electrochemical flow cell on removal of copper ions from acidic contaminated solution containing 10-100 ppm Cu²⁺ in 0.01M H₂SO₄ was evaluated using a stainless steel static mixer electrode (i.e. working electrode) and glassy carbon tube (i.e. anode) at flow rates ranging from 10 to 1000 mL min⁻¹ in a separated configuration embodiment of electrochemical flow cell. As shown in FIG. 10, by increasing the flow rate beyond 50 mL min⁻¹, the removal efficiency decreased which is due to decreasing the resident time of electroactive ions on the surface of working electrode to complete the reduction reaction (FIGS. 10a and 10b). On the other hand, by increasing the flow rate, charge passed through the working electrode has been increased and current recovery is increased accordingly (FIGS. 10c and 10d). However, increasing flow rate is efficient to a point beyond efficiency decreases due to decreasing residence time of electroactive ions at electrode surface.

### Example 3

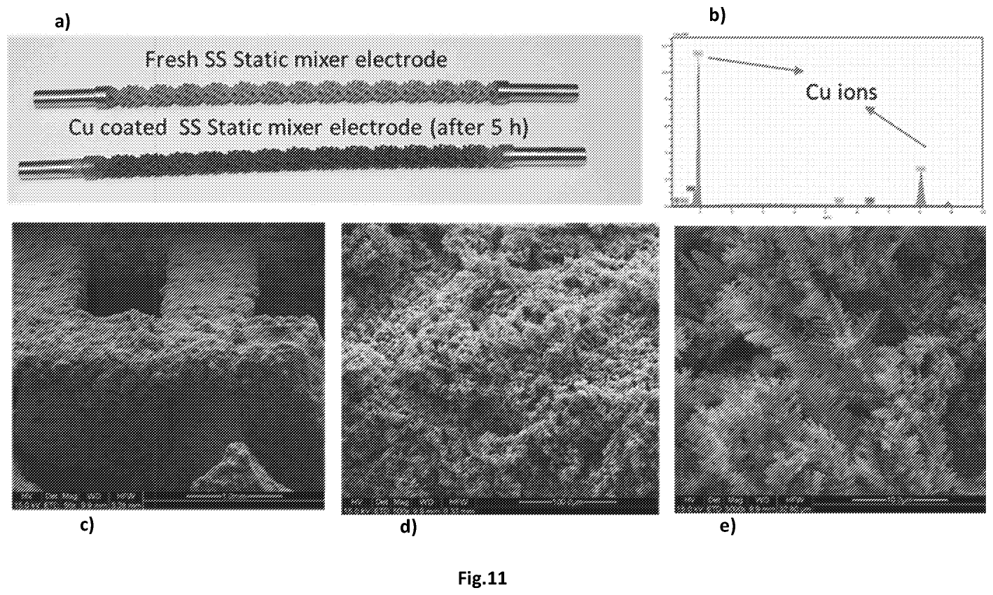

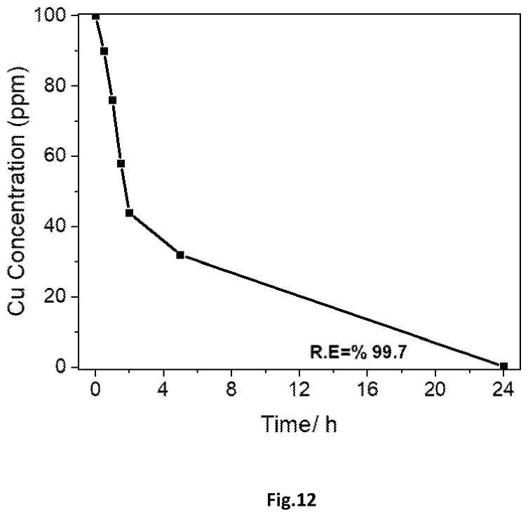

Exhaustive electrolysis experiments were also undertaken to show how effectively the electrochemical flow cell can remove copper ions from a fixed volume of a contaminated aqueous solution. A two Litre solution of copper contaminated water (i.e. 100 ppm CuSO₄.4H₂O in 0.01M H₂SO₄) was processed using the electrochemical flow cell at a constant flow rate of 50 mL min⁻¹ for 24 hours. Optical image and SEM/EDS results confirmed the deposition of copper ions onto the static mixer working electrode (FIG. 11) and ICP-MS results showed that a 99.7% reduction in the copper concentration were achieved in 24 hours in separated configurations of the electrochemical flow cell (FIG. 12).

1. An electrochemical flow cell comprising:
a reaction chamber;
a first electrode;
a second electrode; and
a separator disposed between the first and second electrodes, the separator at least partially defining a first channel within the reaction chamber configured to accommodate a first fluid stream in contact with the first electrode and a second channel within the reaction chamber configured to accommodate a second fluid stream in contact with the second electrode,
wherein the separator comprises a permeable membrane that allows electrical communication between the first and second electrodes via the fluid streams while restricting fluid exchange between the fluid streams, and
wherein the first electrode is a static mixer electrode comprising an electrically conductive static mixer portion defining a plurality of splitting structures that split the first fluid stream into a plurality of sub-streams at a plurality of locations along a length of the first electrode.

2. The electrochemical flow cell according to claim 1, wherein the electrochemical flow cell is a continuous flow tubular reactor.

3. The electrochemical flow cell according to claim 1, wherein a diameter of the static mixer portion of the first electrode is approximately equal to a diameter of the first channel.

4. The electrochemical flow cell according to claim 1, wherein the first electrode is arranged in contact with the separator.

5. The electrochemical flow cell according to claim 1, wherein the separator and second electrode are arranged concentrically and coaxial with a central longitudinal axis of the first electrode.

6. The electrochemical flow cell according to claim 1, wherein the separator and second electrode are substantially cylindrical.

7. The electrochemical flow cell according to claim 1, wherein the second electrode forms at least part of a wall of the reaction chamber.

8-12. (canceled)

13. The electrochemical flow cell according to claim 1, wherein the first electrode comprising the static mixer portion is configured for operating within the first channel to provide a volumetric flow rate for the first fluid stream of at least about 0.1 ml/min.

14. An electrochemical flow system comprising at least a first electrochemical flow cell according to claim 1.

15. The electrochemical flow system of claim 14 further comprising:
a second electrochemical flow cell comprising:
a reaction chamber;
a first electrode;
a second electrode; and
a separator disposed between the first and second electrodes, the separator at least partially defining a first channel within the reaction chamber configured to accommodate a first fluid stream in contact with the first electrode and a second channel within the reaction chamber configured to accommodate a second fluid stream in contact with the second electrode,
wherein the separator comprises a permeable membrane that allows electrical communication between the first and second electrodes via the fluid streams while restricting fluid exchange between the fluid streams, and
wherein the first electrode is a static mixer electrode comprising an electrically conductive static mixer portion defining a plurality of splitting structures that split the first fluid stream into a plurality of sub-streams at a plurality of locations along a length of the first electrode; and
a plurality of flow lines connecting the first electrochemical flow cell to the second electrochemical flow cell such that the first channel of the first electrochemical flow cell is in fluid communication with the second channel of the second electrochemical flow cell, and the second channel of the first electrochemical flow cell is in fluid communication with the first channel of the second electrochemical flow cell.

16. The electrochemical flow system according to claim 14 further comprising:
a pump for providing fluidic flow of the fluid streams;
a power supply for controlling current through, or voltage applied to, the electrodes; and
a controller for controlling one or more parameters of the system comprising concentration, flow rate, temperature, pressure, and residence time.

17. A method for electrochemical treatment of a fluid stream comprising an electrochemical flow cell according to claim 1.

18. The method of claim 17 for treating waste-water, removal of dissolved metal ions from a fluid stream, or recovery of metal from a fluid stream.

19. (canceled)

20. The method of claim 17, wherein the electrochemical flow cell is operated to provide one or more of:
enhance chaotic advection by splitting the first fluid stream by more than 200 m⁻¹, corresponding to a number of times the first fluid stream is split within a given length along the static mixer portion of the first electrode;
provide a Peclet (Pe) number of at least about 10,000;
provide a volumetric flow rate for the first fluid stream of at least about 0.1 ml/min, wherein the first fluid stream comprises a dissolved metal species at a concentration of less than about (in mol/L) 0.01;
provide a recovery efficiency of a contaminant or metal species in the first fluid stream of at least about 90% of the contaminant or metal species initially present in the first fluid stream; and
provide current densities on the static mixer electrode and counter electrode in a range from 1 mA m⁻² to about 1000 A m⁻².

21-26. (canceled)

27. The method according to claim 17, comprising operation of a first and second electrochemical flow cell comprising:
a reaction chamber;
a first electrode;
a second electrode; and
a separator disposed between the first and second electrodes, the separator at least partially defining a first channel within the reaction chamber configured to accommodate a first fluid stream in contact with the first electrode and a second channel within the reaction chamber configured to accommodate a second fluid stream in contact with the second electrode,
wherein the separator comprises a permeable membrane that allows electrical communication between the first and second electrodes via the fluid streams while restricting fluid exchange between the fluid streams,
wherein the first electrode is a static mixer electrode comprising an electrically conductive static mixer portion defining a plurality of splitting structures that split the first fluid stream into a plurality of sub-streams at a plurality of locations along a length of the first electrode, and
wherein a plurality of flow lines connects the first electrochemical flow cell to the second electrochemical flow cell such that the first channel of the first electrochemical flow cell is in fluid communication with the second channel of the second electrochemical flow cell, and the second channel of the first electrochemical flow cell is in fluid communication with the first channel of the second electrochemical flow cell.

28. A method for electrochemical synthesis of a product comprising an electrochemical flow cell according to claim 1.

29. (canceled)

30. The electrochemical flow cell according to claim 2, wherein the static mixer electrode is co-axially aligned substantially along the axis of the continuous flow tubular reactor.

31. The electrochemical flow cell according to claim 1, wherein the scaffold is a metal or metal alloy.

32. The electrochemical flow cell according to claim 1, wherein the static mixer electrode comprises an electrically conductive coating.

33. The method of claim 17, wherein first and second fluid streams comprise liquids.
